(19) United States
(12) Patent Application Publication
(10) Pub. No.: US 2009/0019284 A1
(43) Pub. Date: Jan. 15, 2009

(54) AUTHENTICATION METHOD AND KEY GENERATING METHOD IN WIRELESS PORTABLE INTERNET SYSTEM

(75) Inventors: Seok-Heon Cho, Jeollabuk-do (KR); Sung-Cheol Chang, Daejeon-city (KR); Chul-Sik Yoon, Daejeon-city (KR)

Correspondence Address: Jefferson IP Law, LLP, 1730 M Street, NW, Suite 807, Washington, DC, 20036, US

(73) Assignees: ELECTRONICS AND TELECOMMUNICATIONS RESEARCH INSTIT, Daejeon (KR); SAMSUNG ELECTRINICS CO., LTD., Suwon-si (KR); KT CORPORATION, Seongnam-city (KR); SK TELECOM CO., LTD., Seoul (KR); HANARO TELECOM, INC., Seoul (KR)

(21) Appl. No.: 11/817,859

(22) PCT Filed: Mar. 9, 2006
(86) PCT No.: PCT/KR06/00836

§ 371 Date: Sep. 5, 2007

(30) Foreign Application Priority Data
Mar. 9, 2005 (KR) 10-2005-0019650
Jan. 24, 2006 (KR) 10-2006-0007226

(51) Int. Cl. H04L 9/00

(52) U.S. Cl. 713/170

(57) ABSTRACT

An authentication method and authorization key generation method in a wireless portable Internet system is provided. In a wireless portable Internet system, the base station and the subscriber station share an authorization key when an authentication process is performed according to a predetermined authentication method negotiated therebetween. Particularly, the subscriber station and the base station perform an additional authentication process including an authorization key-related parameter and a security-related parameter and exchanges a security algorithm and SA (Security Association) information. In addition, an authorization key is derived from one or more basic key obtained through various authentication processes as an input key of an authorization key generation algorithm. Therefore, reliability of a security related parameter received from the receiving node can be enhanced and an authorization key having a hierarchical and secure structure can be provided.

### BACKGROUND OF THE INVENTION

(a) Field of the Invention

The present invention relates to an authentication method of a wireless portable Internet system. More particularly, the present invention relates to an authentication method of a wireless portable Internet system and key generation method for generating various keys concerning the authentication method.

(b) Description of the Related Art

In a wireless communication system which is a next-generation communication system, a wireless portable Internet supports mobility for local area data communication such as a conventional wireless local access network (LAN) that uses a fixed access point. Various wireless portable Internet standards have been proposed, and the international standard of the portable Internet has actively progressed on the IEEE 802.16e. The above-described IEEE 802.16 supports a metropolitan area network (MAN) representing an information communication network covering the LAN and the wide area network (WAN).

To securely provide various traffic data services in a wireless portable Internet system, it is required to perform a security function including authentication and authorization functions. In addition, the above functions have been proposed as basic requirements for guaranteeing network stability and wireless portable Internet service security. Recently, a Privacy Key Management Version 2 (PKMv2) which is a security key management protocol for providing a more robust security has been proposed.

The conventional PKMv2 can performs subscriber station or base station equipment authentication and user authentication by variously combining the mutual RSA (Rivest Shamir Adleman)-based authentication method for the subscriber station and base station and the EAP (Extensible Authentication Protocol)-based authentication method using a higher authentication protocol.

When the authentication is performed according to the RSA-based authentication method, the subscriber station and the base station exchange an authentication request message and authentication response message to perform the mutual authentication for the subscriber station and base station. Also, when the authentication process is finished, the subscriber station informs the base station of all subscriber station-supportable security-related algorithms (Security_Capabilities) and the base station negotiates all the subscriber station-supportable security-related algorithms and provides the SA (Security Association) information to the subscriber station.

The messages including the information transmitted between the subscriber station and the base station are transmitted/received wirelessly without additional message authentication functions, and accordingly, there is a problem in that such information is not secured.

Also, using the combination of the RSA-based authentication method and the EAP-based authentication method, an additional SA-TEK (SA-Traffic Encryption Key) process after finishing the authentication process should be performed and the SA information should be provided to the subscriber station in case that only an EAP-based authentication process is performed, in case that the RSA-based authentication process and then the EAP-based authentication process are performed, or in case that the RSA-based authentication process and then the authenticated EAP-based authentication process are performed.

Particularly, in the case that the RSA-based authentication is performed along with the EAP-based authentication method, the EAP-based authentication process is finished and again the SA-TEK process is performed while the SA information is provided to the subscriber station according to the RSA-based authentication process, and accordingly, the subscriber station receives all the subscriber station-related SA information twice from the base station through the RSA-based authentication process and the SA-TEK process. Therefore, there are problems in that the SA information process is unnecessarily repeated, radio resources are wasted, and the authentication process becomes longer. Thus, the conventional authentication method is not performed hierarchically and uniformly.

In addition, there is a problem in that the hierarchic and efficient subscriber station-related authorization key structure are not generated through the authentication methods formed as a various combination.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an authentication method having advantages of providing a hierarchical and efficient authentication method based on PKMv2-based authentication scheme in the wireless portable Internet system. In addition, the present invention has been made in an effort to provide a key generation method for generating an authorization key having a hierarchical structure for authorized subscriber station. In addition, the present invention has been made in an effort to provide a message authentication key generation method based on authorization key. In addition, the present invention has been made in an effort to provide a traffic data encryption key generation and transmission method for stably transmitting traffic data between authorized subscriber station and base station.

An exemplary authentication method according to an embodiment of the present invention performs an authentication process at a first node being a base station or a subscriber station while linking a second node being the subscriber station or the base station in a wireless portable Internet system.

The authentication method includes a) performing an authentication process corresponding to an authentication scheme set by a negotiation between the first node and the second node; b) obtaining one or more basic key for generating an authorization key shared with the second node according to the authentication process; c) generating an authorization key based on a first node identifier, a second node identifier, and the basic key; and d) exchanging a security algorithm and SA (security association) information based on additional authentication process messages including the authorization key-related parameter and security-related parameter.

In addition, an exemplary authentication method according to an embodiment of the present invention performs an authentication process at a first node being a base station or a subscriber station while linking a second node being the subscriber station or the base station in a wireless portable Internet system. The authentication method includes a) performing an authentication process corresponding to an authentication scheme set by a negotiation between the first node and the second node; b) obtaining one or more basic keys for generating an authorization key shared between the first and second nodes according to the authentication process; and c) exchanging a security algorithm and SA (Security Association) information with the second node based on additional authentication process messages including the authorization key-related parameter and security-related parameter, wherein the step c) further comprises generating an authorization key based on the first node identifier, a first random number that the first node randomly generates, the basic key, the second node identifier, and a second random number that the second node randomly generates.

In addition, an exemplary authentication method according to an embodiment of the present invention performs an authentication process at a first node being a base station or a subscriber station while linking a second node being the subscriber station or the base station in a wireless portable Internet system. The authentication method includes a) performing an authentication process corresponding to an authentication scheme set by a negotiation between the first node and the second node; b) obtaining an authorization key shared between the first and second nodes according to the authentication process; and c) exchanging a security algorithm and SA (Security Association) information with the second node based on additional authentication process messages including the authorization key-related parameter and security-related parameter.

In addition, an exemplary key generation method according to an embodiment of the present invention generates authentication-related keys when a first node being a base station or a subscriber station performing an authentication process while linking a second node being the subscriber station or the base station in a wireless portable Internet system. The key generation method includes a) performing an authentication process corresponding to an authentication scheme set by a negotiation between the first node and the second node and obtaining a first basic key for generating an authorization key; b) generating a second basic key from the first basic key; and c) generating the authorization key by performing a key generation algorithm using the second basic key as an input key and using the first node identifier, the second node identifier, and a predetermined string word as input data.

In addition, an exemplary key generation method according to an embodiment of the present invention generates authentication-related keys when a first node being a base station or a subscriber station performing an authentication process while linking a second node being the subscriber station or the base station in a wireless portable Internet system. The key generation method includes a) performing an authentication process corresponding to an authentication scheme set by a negotiation between the first node and the second node and obtaining a first basic key for generating an authorization key; b) generating a second basic key from the first basic key; and c) generating the authorization key by performing a key generation algorithm using the second basic key as the input key and using a first node identifier, a first random number that the first node randomly generates, a second node identifier, a second random number that the second node randomly generates, and predetermined string word as the input data.

An exemplary authorization key generation method according to an embodiment of the present invention generates a message authentication key parameters for a first node being a base station or a subscriber station performing an authentication process while linking a second node being the subscriber station or the base station in a wireless portable Internet system. The authorization key generation method includes a) when an authentication process performs an authenticated EAP-based authentication process after an RSA-based authentication process according to a negotiation between the first node and the second node, the first node obtaining a basic key shared with the second nodes through an RSA-based authentication process; b) obtaining result data by performing a key generation algorithm using the basic key as an input key and using a first node identifier, a second node identifier, and a predetermined string word as input data; c) extracting predetermined bits of the result data and using first predetermined bits of the extracted bits as message authentication keys for generating message authentication code parameter of an uplink message; and d) extracting predetermined bits of the result data and generating second predetermined bits of the extracted bit as a message authentication keys for generating a message authentication code parameter of a downlink message.

### BRIEF DESCRIPTION OF THE DRAWINGS

FIG. 1 is a diagram schematically showing a structure of a wireless portable Internet system according to an exemplary embodiment of the present invention.

FIG. 2 is a table showing an internal parameter configuration of a PKMv2 RSA-Request message used in an RSA-based authentication method according to an exemplary embodiment of the present invention.

FIG. 3 is a table showing an internal parameter configuration of a PKMv2 RSA-Reply message used in an RSA-based authentication method according to an exemplary embodiment of the present invention.

FIG. 4 is a table showing an internal parameter structure of a PKMv2 RSA-Reject message used in an RSA-based authentication method according to an exemplary embodiment of the present invention.

FIG. 5 is a table showing an internal parameter structure of a PKMv2 RSA-Acknowledgement message used in an RSA-based authentication method according to an exemplary embodiment of the present invention.

FIG. 6 is a table showing an internal parameter structure of a PKMv2 EAP-Transfer message used in an EAP-based authentication method according to an exemplary embodiment of the present invention.

FIG. 7 is a table showing an internal parameter structure of a PKMv2 Authenticated-EAP-Transfer message used in an authenticated EAP-based authentication method according to an exemplary embodiment of the present invention.

FIG. 8 is a table showing an internal parameter structure of a PKMv2 SA-TEK-Challenge message used in a SA-TEK process according to an exemplary embodiment of the present invention.

FIG. 9 is a table showing an internal parameter structure of a PKMv2 SA-TEK-Request message used in a SA-TEK process according to an exemplary embodiment of the present invention.

FIG. 10 is a table showing an internal parameter structure of a PKMv2 SA-TEK-Response message used in a SA-TEK process according to an exemplary embodiment of the present invention.

FIG. 11 is a flowchart of an authentication method performing only an RSA-based authentication process according to a first exemplary embodiment of the present invention.

FIG. 12 is a flowchart for generating authorization key in an authentication method performing only an RSA-based authentication process according to a first exemplary embodiment of the present invention.

FIG. 13 is a flowchart of an authentication method performing only an EAP-based authentication process according to a first exemplary embodiment of the present invention.

FIG. 14 is a flowchart for generating authorization key in an authentication method performing only an EAP-based authentication process according to a first exemplary embodiment of the present invention.

FIG. 15 is a flowchart of an authentication method sequentially performing an RSA-based authentication process and EAP-based authentication process according to a first exemplary embodiment of the present invention.

FIG. 16 is a flowchart for generating authorization key in an authentication method sequentially performing an RSA-based authentication process and an EAP-based authentication process according to a first exemplary embodiment of the present invention.

FIG. 17 is a flowchart of an authentication method sequentially performing an RSA-based authentication process and an authenticated EAP-based authentication process according to a first exemplary embodiment of the present invention.

FIG. 18 is a flowchart of an authentication method according to a second exemplary embodiment of the present invention, and particularly, a flowchart showing a SA-TEK process.

FIG. 19 is a flowchart for generating authorization key in an authentication method performing only an RSA-based authentication process according to a second exemplary embodiment of the present invention.

FIG. 20 is a flowchart for generating authorization key in an authentication method performing only an EAP-based authentication process according to a second exemplary embodiment of the present invention.

FIG. 21 is a flowchart for generating authorization key in an authentication method sequentially performing an RSA-based authentication process and an EAP-based authentication process according to a second exemplary embodiment of the present invention.

FIG. 22 is a flowchart for generating an HMAC key or a CMAC key for authenticating a message using an EIK according to first and second exemplary embodiments of the present invention.

FIG. 23 is a table showing an internal parameter structure of a PKMv2 Key-Request message among messages used in a traffic encryption key generation and distribution process according to exemplary embodiments of the present invention.

FIG. 24 is a table showing an internal parameter structure of a PKMv2 Key-Reply message among messages used in a traffic encryption key generation and distribution process according to exemplary embodiments of the present invention.

FIG. 25 is a table showing an internal parameter structure of a PKMv2 Key-Reject message among messages used in a traffic encryption key generation and distribution process according to exemplary embodiments of the present invention.

FIG. 26 is a table showing an internal parameter structure of a PKMv2 SA-Addition message among messages used in a traffic encryption key generation and distribution process for dynamically generating and distributing one or more traffic encryption key according to exemplary embodiments of the present invention.

FIG. 27 is a table showing an internal parameter structure of a PKMv2 TEK-Invalid message among messages used in a traffic encryption key error informing process according to exemplary embodiments of the present invention.

FIG. 28 is a flowchart showing a traffic encryption key generation and distribution process according to exemplary embodiments of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive.

Throughout this specification and the claims which follow, unless explicitly described to the contrary, the word “comprise” or variations such as “comprises” or “comprising” will be understood to imply the inclusion of stated elements but not the exclusion of any other elements.

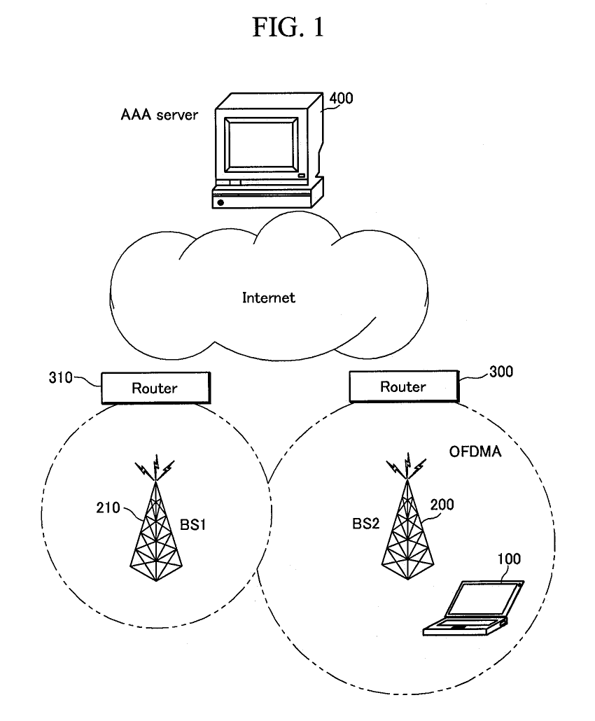

FIG. 1 is a diagram schematically showing a structure of a wireless portable Internet system according to an exemplary embodiment of the present invention.

The wireless portable Internet system basically includes a subscriber station 100, base stations 200 and 210 (hereinafter, selectively denoted by “200” for convenience of description), routers 300 and 310 connected to the base station through a gateway, and an Authentication Authorization and Accounting (AAA) server 400 for authenticating the subscriber station 100, connected to the routers 300 and 310.

When the subscriber station 100 and the base station 200 or 210 try to communicate with each other, they negotiate an authentication mode for authenticating the subscriber station 100 and perform an authentication process in the selected authentication mode. When a Rivest Shamir Adleman (RSA)-based authentication mode is selected, it is performed in a Media Access Control (MAC) layer of the subscriber station and the base station, and when an Extensible Authentication Protocol (EAP)-based authentication mode is selected, it is performed in a higher EAP layer of the subscriber station and the AAA server. According to an exemplary embodiment of the present invention, a higher EAP authorization protocol layer of the respective nodes is placed on the higher layer than the MAC layer so that it performs an EAP authorization process, and it includes an EAP layer as a transmission protocol of various authentication protocols and an authentication protocol layer for performing an actual authentication such as a TLS (Transport Level Security) or TTLS (Tunneled TLS) protocol.

The higher EAP authorization protocol layer performs an EAP authorization with data transmitted from the MAC layer and transmits the EAP authentication information to the MAC layer. Therefore, the information is processed into various message formats relating to the EAP authentication through the MAC layer and is then transmitted to the other node.

The MAC layer performs a total control for the wireless communication and is functionally divided into a MAC Common Part Sublayer (hereinafter, referred to as “MAC CPS”) for charging system access, bandwidth allocation, traffic connection addition and maintenance, and Quality of Service (QoS) managing functions, and a Service Specific Convergence Sublayer (hereinafter, referred to as “MAC CS”) charging payload header suppression and QoS mapping functions. In such a hierarchical structure, a Security Sublayer for performing a subscriber station or base station equipment authentication function and a security function including a security key exchange function and an encryption function may be defined in the MAC common part sublayer, but is not limited thereto.

An authentication policy performed between the subscriber station 100 and the base station 200 according to the exemplary embodiment of the present invention is based on authentication policies according to the PKMv2. The authentication policies according to the PKMv2 are classified into four types according to a combination of an RSA-based authentication method, an EAP-based authentication method, and an authenticated EAP-based authentication method.

The first type is a Rivest Shamir Adleman (RSA)-based authentication method for performing mutual equipment authorization of the subscriber station and the base station, and the second type is an Extensible Authentication Protocol (EAP)-based authentication method for performing equipment authentication of the subscriber station and the base station and a user authentication by using a higher EAP protocol. As the third type, there is a combination of the two methods, in which the RSA-based authentication for the mutual equipment authentication of the subscriber station and the base station is performed and then the EAP-based authentication for the user authentication is performed. Another is an authenticated EAP-based authorization method performed by using a key yielded from the RSA-based authorization method or the EAP-based authorization method after performing the RSA-based authentication or the EAP-based authentication for the equipment authentication of the subscriber station and the base station.

The authenticated EAP-based authorization method is the same as the EAP-based authorization method in that the authenticated EAP-based authorization method uses a higher EAP protocol, but authenticates a message used when the subscriber station and base station transmit the higher EAP protocol, unlike the EAP-based authorization method. The authenticated EAP-based authorization method determines a Message Authentication Code mode (MAC mode) to be used to perform a message authentication function between the subscriber station and base station through a subscriber station basic capability negotiation process before the subscriber station and base station perform an actual authentication process. A Hash Message Authentication Code (HMAC) or a Cipher-based Message Authentication Code (CMAC) is determined according to the MAC mode.

According to exemplary embodiments of the present invention, one authentication method selected among the four authentication methods described above is performed in response to the negotiation between the subscriber station and base station. In addition, the subscriber station and base station performs a SA_TEK process so as to exchange a subscriber station security algorithm and SA information after one authentication method selected among the four authentication methods described above is performed.

According to the first exemplary embodiment of the present invention, while one authentication method selected from among the four authentication methods described above is performed, the subscriber station and base station provide a PKMv2 framework to use a Primary Authorization Key (PAK) obtained through the RSA-based authentication process or a Pairwise master Key (PMK) obtained through the EAP-based authorization process or authenticated EAP-based authorization, a subscriber station identifier, that is, a subscriber station MAC address, and a base station identifier (BS ID), in order to generate an Authorization Key (AK).

In addition, according to the second exemplary embodiment of the present invention, the subscriber station and base station provide a PKMv2 framework to use a subscriber station random number (MS_Random) and a base station random number (BS_Random) which are included during the SA_TEK process and randomly generated as well as a primary authorization key (PAK) obtained through the RSA-based authentication process or a pairwise master key (PMK) obtained through the EAP-based authorization process or authenticated EAP-based authorization, a subscriber station identifier, that is, a subscriber station MAC address, and a base station identifier (BS ID), in order to generate the authorization key.

In the exemplary embodiments of the present invention, the subscriber station MAC address is used as the subscriber station identifier, but is not limited thereto. Therefore, other information that is capable of distinguishing the corresponding subscriber station may be used instead of the subscriber station MAC address so as to generate the authorization key.

First, a structure of a message used for the authentication will be described in detail before describing authentication methods according to the respective exemplary embodiments.

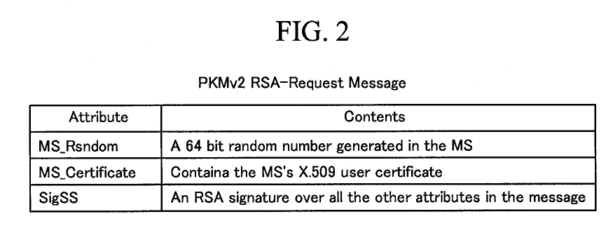

FIG. 2 is a table showing an internal parameter structure of a PKMv2 RSA-Request message used in an RSA-based authentication method according to an exemplary embodiment of the present invention.

A PKMv2 RSA-Request message is used when the subscriber station requests a subscriber station equipment authentication for the base station, and it may be referred to as an “RSA authentication request message.”

In more detail, the PKMv2 RSA-Request message includes a subscriber station random number (MS_Random), a subscriber station certificate (MS_Certificate), and a message authentication parameter (SigSS).

The subscriber station random number (MS_Random) is a value (i.e., of 64 bits) that the subscriber station randomly generates, and is for preventing a replay attack from an illegal attacker.

The subscriber station certificate includes a Public Key of the subscriber station. When the base station receives the subscriber station certificate, it performs an authorization for subscriber station equipment based on the subscriber station certificate.

The message authentication parameter (SigSS) is used to authenticate the PKMv2 RSA-Request message itself. The subscriber station generates the message authentication parameter (SigSS) by applying other parameters of the PKMv2 RSA-Request message excluding the SigSS to the Message Hash function (i.e., RSA algorithm) based on a subscriber station Private Key.

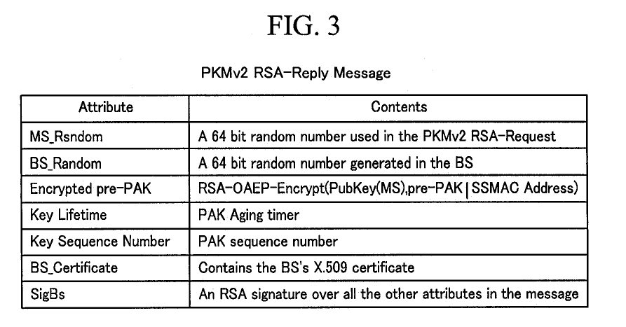

FIG. 3 is a table showing an internal parameter structure of a PKMv2 RSA-Reply message used in an RSA-based authentication method according to an exemplary embodiment of the present invention.

The PKMv2 RSA-Reply message is used in the case that the base station requests a base station equipment authentication of the subscriber station when the subscriber station equipment authentication is successfully performed according to the PKMv2 RSA-Request message, and may be referred to as an “RSA authentication response message.”

In more detail, the PKMv2 RSA-Reply message includes a subscriber station random number (MS_Random), a base station random number (BS_Random), an encrypted pre-PAK, a Key Lifetime, a Key Sequence Number, a base station certificate (BS_Certificate), and a message authentication parameter (SigBS).

The subscriber station random number (MS_Random) is equal to the subscriber station random number (MS_Random) included in the PKMv2 RSA-Request message. The base station random number (BS_Random) is a value (i.e., of 64 bits) that the base station randomly generates.

Such subscriber station random number (MS_Random) and base station random number (BS_Random) are parameters for preventing a replay attack from an illegal attacker.

The encrypted pre-PAK is generated by encrypting a value (pre-PAK) that the base station randomly generates with the subscriber station public key included in a subscriber station certificate (MS_Certificate) among internal parameters of the PKMv2 RSA-Request message. For example, the pre-PAK may be a value of 256 bits that the base station randomly generates.

The Key Lifetime is given as an effective time of the PAK, and the Key Sequence Number is given as a sequence number of the PAK. The base station certificate (BS_Certificate) includes a base station public key. In addition, the subscriber station performs an authorization for base station equipment based on the base station certificate. The message authentication parameter (SigBS) is used to authenticate the PKMv2 RSA-Reply message. The base station generates the message authentication parameter (SigBS) by applying other parameters of the PKMv2 RSA-Reply message excluding the SigBS to the Message Hash function (i.e., an RSA algorithm) based on a base station Private Key.

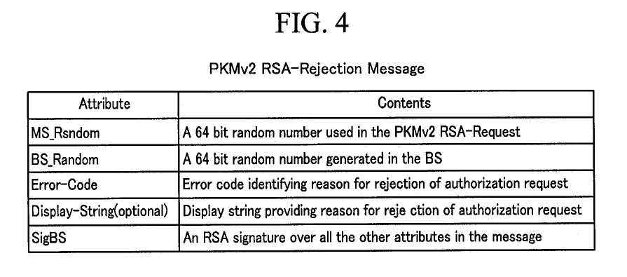

FIG. 4 is a table showing an internal parameter structure of a PKMv2 RSA-Reject message used in an RSA-based authentication method according to an exemplary embodiment of the present invention.

The PKMv2 RSA-Reject message is used to inform that the base station received the PKMv2 RSA-Request message fails to authenticate the subscriber station equipment, and may be referred to as an “RSA authentication failure message.”

In more detail, the PKMv2 RSA-Reject message includes a subscriber station random number (MS_Random), a base station random number (BS_Random), an Error Code, a Display-String, and a message authentication parameter (SigBS).

The subscriber station random number (MS_Random) is equal to the subscriber station random number (MS_Random) included in the PKMv2 RSA-Request message, and the base station random number (BS_Random) is a value (i.e., of 64 bits) that the base station randomly generates. The base station random number (BS_Random) is a parameter for preventing a replay attack from an illegal attacker.

The Error Code provides a reason that the base station fails to authenticate the subscriber station equipment, and the Display-String provides a reason that the base station fails to authenticate the subscriber station equipment as a string. The message authentication parameter (SigBS) is used to authenticate the PKMv2 RSA-Reject message itself. The base station generates the SigBS by applying other parameters of the PKMv2 RSA-Reject message excluding the SigBS to the Message Hash function (i.e., an RSA algorithm) based on a base station Private Key.

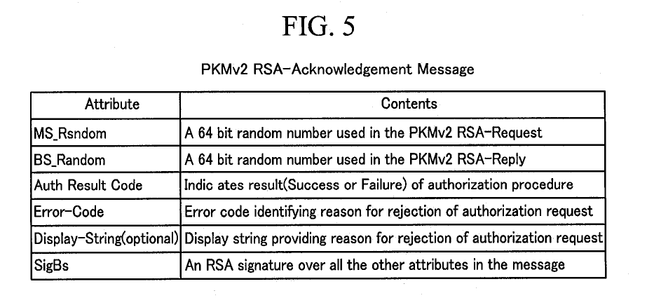

FIG. 5 is a table showing an internal parameter structure of a PKMv2 RSA-Acknowledgement message used in an RSA-based authentication method according to an exemplary embodiment of the present invention.

A PKMv2 RSA-Acknowledgement message is used to inform that the subscriber station received the PKMv2 RSA-Reply message succeeds in authenticating the base station equipment, and may be referred to as an “RSA authentication recognizing message.”

When the base station receives the PKMv2 RSA-Acknowledgement message including a success authentication for the base station equipment, the RSA-based authentication process is finished.

In more detail, the PKMv2 RSA-Acknowledge message includes a subscriber station random number (MS_Random) and a base station random number (BS_Random), an authentication result code (Auth Result Code), and a message authentication parameter (SigSS), and selectively contains an Error Code and a Display-String.

The subscriber station random number (MS_Random) is equal to the subscriber station random number (MS_Random) included in the PKMv2 RSA-Request message, and the base station random number (BS_Random) is equal to the base station random number (BS_Random) included in the PKMv2 RSA-Reply message.

The authentication result code is for informing of authorization result (success or failure) for a base station equipment. The Error Code and Display-String are only defined when a value of the authentication result code is a failure. The Error Code provides a reason that the subscriber station fails to authenticate the base station equipment, and the Display-String provides a reason that the subscriber station fails to authenticate the base station equipment as a string.

The message authentication parameter (SigBS) is used to authenticate the PKMv2 RSA-Acknowledgement message. The subscriber station generates the SigSS by applying other parameters of the PKMv2 RSA-Acknowledgement message excluding the SigSS to the Message Hash function (i.e., an RSA algorithm) based on a subscriber station Private Key.

Meanwhile, the EAP-based authorization method or authenticated EAP-based authorization method according to an exemplary embodiment of the present invention uses a PKMv2 EAP-Start message.

The PKMv2 EAP-Start message is used when the subscriber station informs the base station that the EAP-based authorization method or authenticated EAP-based authorization method starts, and may be referred to as an “EAP authorization start message.”

Such a PKMv2 EAP-Start message includes no detailed parameters, but is not limited thereto.

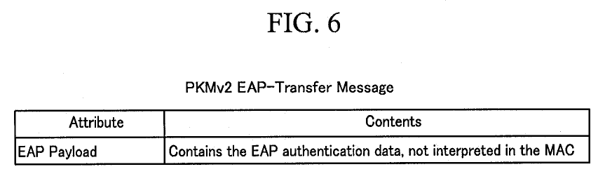

FIG. 6 is a table showing an internal parameter structure of a PKMv2 EAP-Transfer message used in an EAP-based authentication method according to an exemplary embodiment of the present invention.

A PKMv2 EAP-Transfer message is used to transmit EAP data to the receive node (subscriber station or base station) when the subscriber station or the base station receives EAP data from a higher EAP authorization protocol, and it may be referred to as an “EAP data transfer message.”

In more detail, the PKMv2 EAP-Transfer message includes an EAP Payload. The EAP Payload is given as the EAP data received from the higher EAP authorization protocol. The EAP Payload is not analyzed by the MAC layer of the subscriber station or the base station.

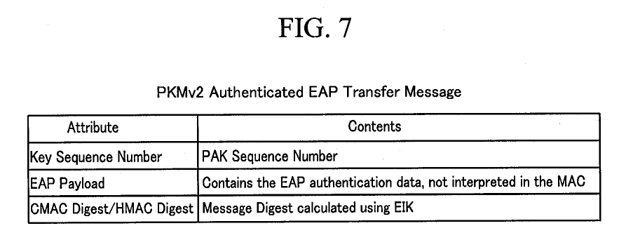

FIG. 7 is a table showing an internal parameter structure of a PKMv2 Authenticated-EAP-Transfer message used in an EAP-based authentication method according to an exemplary embodiment of the present invention.

A PKMv2 Authenticated-EAP-Transfer message is used to transfer the corresponding EPA data to the receive node (subscriber station or base station) when the subscriber station or the base station receives EAP data from a higher EAP authorization protocol. The PKMv2 Authenticated-EAP-Transfer message may be referred to as an “authenticated EAP data transfer message.”

The PKMv2 Authenticated-EAP-Transfer message includes a message authentication function unlike the PKMv2 EAP-Transfer message. The message specifically includes a Key Sequence Number, an EAP Payload, and a message authentication code parameter, CMAC-Digest or HMAC-Digest.

The Key Sequence Number is a sequence number of the PAK. Keys for generating the message authentication code parameter, CMAC-Digest or HMAC-Digest, included in the PKMv2 Authenticated-EAP-Transfer message are derived with the pre-PAK obtained through the RSA-based authentication process. The PAK sequence number is desired to distinguish between two pre-PAKs because a subscriber station and a base station may simultaneously have the two pre-PAKs. At this time, the PAK sequence number is equal to the pre-PAK sequence number. Therefore, the Key Sequence Number indicates the PAK sequence number for the pre-PAK used when the message authentication code parameter is generated.

The EAP Payload indicates EAP data received from the higher EAP authorization protocol as described above.

The message authentication code parameter, CMAC-Digest or HMAC-Digest, is used to authenticate the PKMv2 Authenticated-EAP-Transfer message. The subscriber station or the base station generates an EIK (EAP Integrity Key) with the pre-PAK shared through the RSA-based authentication process. The CMAC-Digest or HMAC-Digest is generated by applying other parameters of the PKMv2 Authenticated-EAP-Transfer message excluding the message authentication code parameter to the Message Hash function (i.e., RSA algorithm) based on the EIK generated in this manner.

Meanwhile, the EAP-based authorization method or authenticated EAP-based authorization method according to an exemplary embodiment of the present invention uses a PKMv2 EAP-Transfer-Complete message.

The PKMv2 EAP-Transfer-Complete message is used to inform the base station that the subscriber station successfully finishes the EAP-based authorization process or authenticated EAP-based authorization process, and may be referred to as an “EAP authorization success message.”

The PKMv2 EAP-Transfer-Complete message includes no parameter, but is not limited thereto.

These messages (the PKMv2 RSA-Request message, PKMv2 RSA-Request message, PKMv2 RSA-Reject message, PKMv2 RSA-Reject message, PKMv2 EAP-Start message, PKMv2 EAP-Transfer message, PKMv2 Authenticated-EAP-Transfer message, and PKMv2 EAP-Transfer-Complete message) are identically applied to the first and second exemplary embodiments.

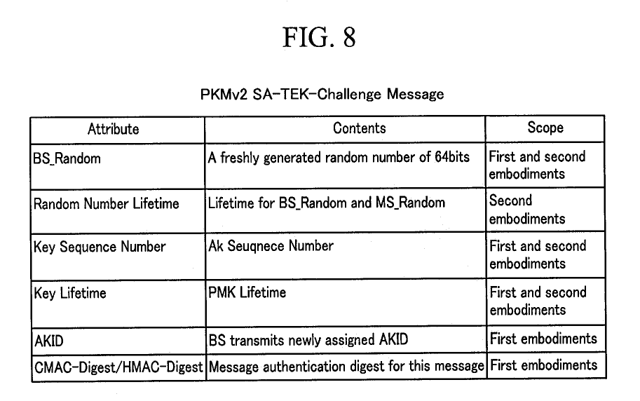

FIG. 8 is a table showing an internal parameter structure of a PKMv2 SA-TEK-Challenge message used in a SA-TEK process according to an exemplary embodiment of the present invention.

A PKMv2 SA-TEK-Challenge message is used when the base station informs the subscriber station that a SA-TEK process is started after the authentication process between the subscriber station and the base station has been finished. It may be referred to as a “SA-TEK challenge message.”

In the case of the first exemplary embodiment using the PAK or PMK (which may be referred to as a basic key for generating an authorization key), the subscriber station MAC address, and the base station identifier so as to generate an authorization key, the PKMv2 SA-TEK-Challenge message includes the base station random number (BS_Random), the Key Sequence Number, the Authorization Key-identifier (AK-ID), and a message authentication code parameter (CMAC-Digest or HMAC-Digest), and selectively contains a Key Lifetime.

The base station random number (BS_Random) is a value that the base station randomly generates as described above. The base station random number (BS_Random) is a parameter for preventing a replay attack from an illegal attacker.

The Key Sequence Number is given as a consecutive number of the authorization key. A key for generating the CMAC-Digest or HMAC-Digest included in the PKMv2 SA-TEK-Challenge message is derived from the authorization key. The Authorization key sequence number is used to distinguish between two authorization keys because a subscriber station and a base station may simultaneously have the two authorization keys.

The Key Lifetime is an effective time of the PMK. This field must support the EAP-based authorization method or the authenticated EAP-based authorization method, and it may be defined only when the subscriber station and the base station share an MSK according to a characteristic of the higher EAP authorization protocol.

The Authorization Key Identifier may be derived from the authorization key, the authorization key sequence number, the subscriber station MAC address, and the base station identifier. The Authorization Key Identifier is independently generated by the subscriber station and the base station, and is transmitted from the base station to the subscriber station so as to confirm that the base station and the subscriber station have the same Authorization Key Identifier.

The Authorization key sequence number is generated in combination of the PAK sequence number and the PMK sequence number. The Authorization key sequence number included in the PKMv2 SA-TEK-Challenge message is for informing of the PMK sequence number. This is because the PAK sequence number may be included in the PKMv2 RSA-Reply message of the RSA-based authentication process and the PMK sequence number may not be included in any messages of the EAP-based authentication process.

The Authorization Key Identifier is formed through such an authorization key sequence number. The Authorization key sequence number and the Authorization Key Identifier all both used to distinguish between two authorization keys in the case that the subscriber station and the base station simultaneously have two authorization keys. The all neighbor base stations have the same authorization key sequence number if the re-authentication process is not necessary in the case that the subscriber station requests a handover. However, the base stations have different Authorization Key Identifiers.

The message authentication code parameter, CMAC-Digest or HMAC-Digest, is used to authenticate the PKMv2 SA-TEK-Challenge message. The base station generates the CMAC-Digest or HMAC-Digest by applying other parameters included in the PKMv2 SA-TEK-Challenge message excluding the message authentication code parameter to the Message Hash function based on the Authorization Key.

In the case of the second exemplary embodiment using the subscriber station random number (MS random) and the base station random number (BS random) that the subscriber station and the base station randomly generate as well as a PAK or PMK (which may be referred to as a basic key for generation of an authorization key), a subscriber station MAC address, and a base station identifier so as to generate the authorization key, the base station transmits the PKMv2 SA-TEK-Challenge message to the subscriber station so as to inform a SA_TEK process start, after the authentication process between the base station and the subscriber station has been finished.

The PKMv2 SA-TEK-Challenge message used in the second exemplary embodiment includes the base station random number (BS_Random), the Random Lifetime, and the Key Sequence Number, unlike the first exemplary embodiment, and it may include a Key Lifetime for the PMK when both the subscriber station and the base station support the EAP-based authorization method or the authenticated EAP-based authorization method and share an MSK according to a characteristic of the higher EAP authorization protocol. The Random Lifetime indicates effective time for the subscriber station random number and base station random number.

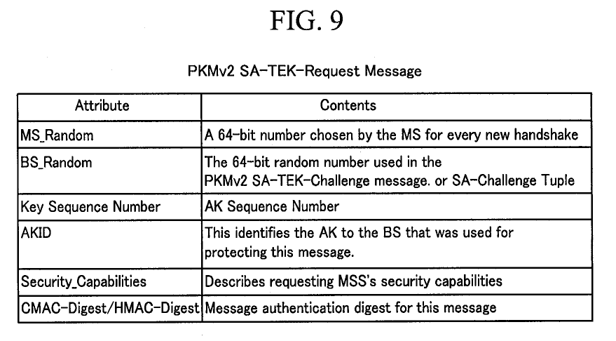

FIG. 9 is a table showing an internal parameter structure of a PKMv2 SA-TEK-Request message used in a SA-TEK process according to an exemplary embodiment of the present invention.

The PKMv2 SA-TEK-Request message is for informing of all security algorithms that the subscriber station can support, and it may be referred to as a “SA-TEK request message.”

In the first exemplary embodiment, the subscriber station transmits the PKMv2 SA-TEK-Request message including all security-related algorithms that the subscriber station can support to the base station when the subscriber station receives the PKMv2 SA-TEK-Challenge message, successfully authenticates the corresponding message, and then confirms that the Authorization Key Identifier, particularly the generated Authorization Key Identifier by subscriber station itself, is equal to the Authorization Key Identifier included in the PKMv2 SA-TEK Challenge message received from the base station. In the second exemplary embodiment, the subscriber station transmits the PKMv2 SA-TEK-Request message including all the security-related algorithms that the subscriber station can support when the subscriber station receives the PKMv2 SA-TEK-Challenge message and successfully authenticates the corresponding message.

The PKMv2 SA-TEK-Request message includes a subscriber station random number (MS_Random) and a base station random number (BS_Random), a Key Sequence Number, an Authorization Key Identifier, subscriber station security algorithm capabilities (Security_Capabilities), and a message authentication code parameter (CMAC-Digest or HMAC-Digest).

The subscriber station random number (MS_Random) is a value (i.e., of 64 bits) that the subscriber station randomly generates, and the base station random number (BS-Random) is equal to the base station random number (BS-Random) included in the PKMv2 SA-TEK-Challenge message. The subscriber station random number (MS_Random) is a parameter for preventing a replay attack from an illegal attacker.

The Key Sequence Number is an authorization key sequence number for distinguishing between the authorization keys used to derive the keys for generating the message authentication code parameter, CMAC-Digest or HMAC-Digest, included in the PKMv2 SA-TEK-Request message as described above.

The Authorization Key Identifier is derived from the authorization key, the sequence number thereof, the subscriber station MAC address, and the base station identifier.

The subscriber station security algorithm capability is a parameter for indicating the entire security algorithm that the subscriber station can support. The message authentication code parameter, CMAC-Digest or HMAC-Digest, is a parameter used to authenticate the PKMv2 SA-TEK-Request message. The subscriber station generates the CMAC-Digest or HMAC-Digest by applying other parameters of the PKMv2 SA-TEK-Request message excluding the message authentication code parameter to the Message Hash function based on the authorization key.

In the first exemplary embodiment, the Authorization Key Identifier included in the PKMv2 SA-TEK-Request message is equal to the Authorization Key Identifier included in the PKMv2 SA-TEK-Challenge message.

Meanwhile, in the second exemplary embodiment, the Authorization Key Identifier included in the PKMv2 SA-TEK-Request message is generated based on the authorization key that the subscriber station generates, the sequence number of the authorization key, the subscriber station MAC address, and the base station identifier.

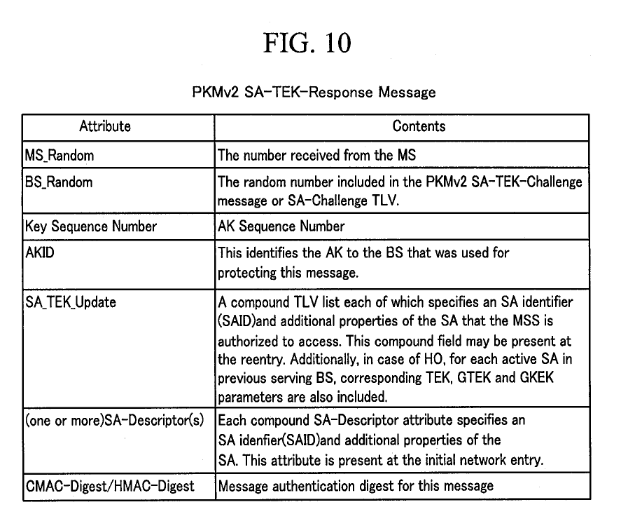

FIG. 10 is a table showing an internal parameter structure of a PKMv2 SA-TEK-Response message used in a SA-TEK process according to an exemplary embodiment of the present invention.

A PKMv2 SA-TEK-Response message is used when the base station transmits SA information to the subscriber station, and it may be referred to as a “SA-TEK reply message.”

In more detail, the base station transmits the PKMv2 SA-TEK-Response message including all SA information to the subscriber station when the base station received the PKMv2 SA-TEK-Request message successfully authenticates the corresponding message, and then confirms that the containing Authorization Key Identifier, particularly an Authorization Key Identifier that the base station generates, is equal to the Authorization Key Identifier included in the PKMv2 SA-TEK Request message.

The PKMv2 SA-TEK-Response message includes a subscriber station random number MS_Random and base station random number BS_Random, a Key Sequence Number, an Authorization Key Identifier, SA-TEK update information (SA_TEK_Update), one or more SA descriptor (SA-Descriptor), and a message authentication code parameter (CMAC-Digest or HMAC-Digest).

The subscriber station random number MS_Random is equal to the subscriber station random number MS_Random included in the PKMv2 SA-TEK Request message received from the subscriber station, and the base station random number BS_Random is equal to the base station random number BS_Random included in the PKMv2 SA-TEK-Challenge message.

The Key Sequence Number is a consecutive number of the Authorization Key. The key for generating the CMAC-Digest or HMAC-Digest included in the PKMv2 SA-TEK-Response message is derived from the authorization key. The authorization key needs a consecutive number thereof so as to distinguish between the two authorization keys to be simultaneously included in the subscriber station and the base station.

The Authorization Key Identifier is derived from the authorization key, the sequence number thereof, the subscriber station MAC address, and the base station identifier.

The SA-TEK update information (SA_TEK_Update) is a parameter including SA information, and is used during the handover process or the network re-entry process. The SA descriptor (SA-Descriptor) is a parameter including the SA information, and is used during an initial network entry process. However, it is not limited thereto.

In more detail, the SA descriptor specifically includes a SAID, that is, a SA identifier, a SA type for informing of a type of SA, a SA service type for informing of a form of SA traffic service that is defined when the SA type is given as a dynamic SA or a stable SA, and a Cryptographic-Suite for informing of an encryption algorithm to be used in the corresponding SA. The SA descriptor may be repeatedly defined by the number of SAs that the base station dynamically generates.

The message authentication code parameter, CMAC-Digest or HMAC-Digest, is a parameter used to authenticate the PKMv2 SA-TEK-Response message itself. The base station generates the CMAC-Digest or HMAC-Digest by applying other parameters of the PKMv2 SA-TEK-Response message excluding the message authentication code parameter to the Message Hash function based on the authorization key.

In the first exemplary embodiment, the Authorization Key Identifier of the PKMv2 SA-TEK-Response message is equal to the Authorization Key Identifier included in the PKMv2 SA-TEK-Challenge message. Meanwhile, in the second exemplary embodiment, the Authorization Key Identifier of the PKMv2 SA-TEK-Response message is equal to the Authorization Key Identifier included in the PKMv2 SA-TEK-Request message.

An authentication method and an authentication-related key generation method according to an exemplary embodiment of the present invention will now be described in detail based on the message described above.

An authentication method according to an exemplary embodiment of the present invention performs an authentication based on various policies generated according to a combination of the RSA-based authentication method, the EA-based authentication method, and the authenticated EAP-based authorization method. Particularly, the authentication is performed according to the predetermined process and then the subscriber station and the base station perform a SA-TEK process so as to exchange the subscriber station security algorithm and Security Association (SA) information.

The conventional PKMv2 authentication policy has problems in that two processes, that is, the RSA-based authentication process and the SA-TEK process, repeatedly exchange the subscriber station security algorithm and SA information, and the same exchanged in the RSA-based authentication process is unreliable because the messages exchanged between the subscriber station and the base station is not authenticated in the RSA-based authentication process.

Therefore, according to an exemplary embodiment of the present invention, the subscriber station and base station exchange the subscriber station security algorithm and SA information through the SA-TEK process for supporting the message authentication function thereto.

First, the authentication method and the authorization key generation method according to the first exemplary embodiment of the present invention will be described.

A first example according to the first exemplary embodiment of the present invention performs only the RSA-based authentication process.

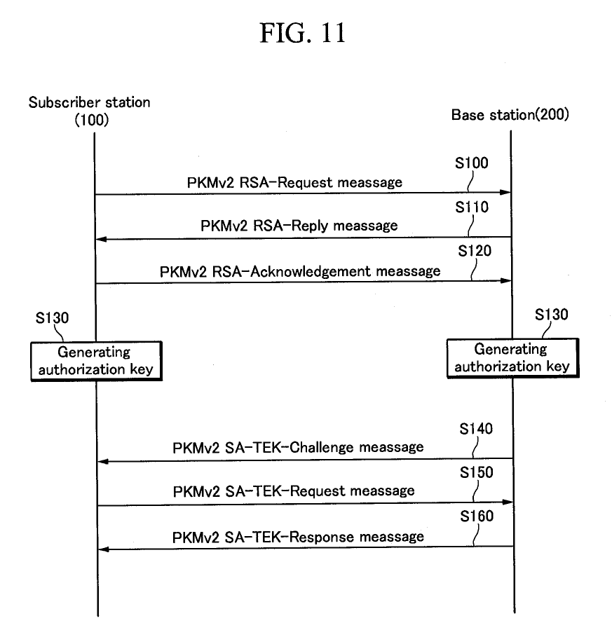

FIG. 11 is a flowchart of an authentication method for performing only an RSA-based authentication process according to a first example of the first exemplary embodiment of the present invention.

An authentication method may be selected while performing a subscriber station basic capability negotiation process before the subscriber station 100 and the base station 200 perform an actual authentication process.

When the selected authentication method performs only the RSA-based authentication process, the subscriber station 100 transmits a digital certificate to the base station through the PKM message, that is, an authentication message among the MAC messages as shown in FIG. 11. In further detail, the subscriber station 100 adds a certificate including the subscriber station public key to the PKMv2 RSA-Request message, and transmits the added message to the base station 200 (S100).

The base station 200 received the PKMv2 RSA-Request message from the subscriber station 100 performs the corresponding subscriber station equipment authentication, and transmits the base station certificate and the PKMv2 RSA-Reply message including a pre-PAK encrypted with a subscriber station public key to the subscriber station 100 so as to request base station equipment authentication, when the subscriber station equipment authentication is successfully completed (S110). On the other hand, the base station 200 transmits the PKMv2 RSA-Reject message to the subscriber station 100 and informs of an equipment authentication failure when the subscriber station equipment authentication is not successfully completed.

The subscriber station 100 receiving the PKMv2 RSA-Reply message from the base station 200 verifies the base station certificates included in the message to perform a base station equipment authentication, and transmits the PKMv2 RSA-Acknowledgement message including a result thereof to the base station 200 (S120). As such, the RSA-based authentication is performed even at the subscriber station, and when the base station equipment authentication is successfully completed, the subscriber station 100 transmits the PKMv2 RSA-Acknowledgement message including the success result to the base station 200, and accordingly the RSA-based mutual authentication process is completed.

When the RSA-based authentication process is successfully completed, the subscriber station 100 and the base station 200 shares a pre-PAK and generate a PAK using the pre-PAK. In addition, the subscriber station 100 and the base station 200 respectively generate an Authorization Key (AK) using the PAK, the subscriber station MAC address, and the base station identifier (S130).

After the RSA-based authentication process is finished, the subscriber station 100 and the base station 200 perform the SA-TEK process so as to exchange the subscriber station security algorithm and SA (Security Association) information. In more detail, after the RSA-based authentication process is finished, the subscriber station 100 and the base station 200 perform a 3-Way SA-TEK exchange process so as to synchronize the Authorization Key Identifier, the sequence number thereof, the SAID, the algorithm to be used for the respective SAs, and the Traffic Encryption Keys (TEKs).

As shown in FIG. 11, the base station 200 for generating the authorization key through the authentication process transmits the PKMv2 SA-TEK-Challenge message to the subscriber station 100, and accordingly starts the SA-TEK process (S140).

At this time, the base station 200 provides the sequence number of the authorization key and the Authorization Key Identifier (AK-ID) to the subscriber station 100 through the PKMv2 SA-TEK-Challenge message. The PKMv2 RSA-Reply message includes the PAK sequence number, and accordingly, the sequence number of the authorization key of the PKMv2 SA-TEK-Challenge message is equal to the PAK sequence number included in the PKMv2 RSA-Reply message.

In addition, the subscriber station 100 can perform the message authentication function based on the message authentication code parameter, CMAC-Digest or HMAC-Digest, included in the PKMv2 SA-TEK-Challenge message.

In more detail, the subscriber station 100 generates a new message authentication code parameter by applying other parameters of the received PKMv2 SA-TEK-Challenge message excluding the message authentication code parameter to the Message Hash function based on the authorization key. In addition, the subscriber station 100 determines whether the generated message authentication code parameter is equal to the message authentication code parameter included in the PKMv2 SA-TEK-Challenge message, and accordingly regards it as a message authentication success when these parameters are identical and as an authentication failure when these parameters are not identical. When the message authentication is successfully finished, it is regarded that the subscriber station and the base station share the same authorization key. However, when the message authentication is not successfully finished, the subscriber station 100 discards the received message.

According to an exemplary embodiment of the present invention, the message authentication is performed through the processes described above when the message authentication code parameter (CMAC-Digest or HMAC-Digest) is included in the message transmitted/received between the subscriber station and the base station, and a predetermined process is performed based on the corresponding message when the message authentication is successfully finished. Meanwhile, in the case of the PKMv2 Authenticated-EAP-Transfer message using the authenticated EAP-based authorization method described hereinafter, the message authentication code parameter may be generated based on the EAP Integrity Key (EIK) instead of the authorization key to perform the message authentication.

As described above, it is determined whether the Authorization Key Identifier included in the PKMv2 SA-TEK-Challenge message is equal to the subscriber station-contained Authorization Key Identifier, and particularly, the subscriber station-generated Authorization Key Identifier (this identifier is generated based on the authorization key sequence number included in the PKMv2 SA-TEK-Challenge message, the known authorization key, the base station identifier, and the subscriber station MAC address) when the PKMv2 SA-TEK-Challenge message is successfully authenticated based on the message authentication code parameter, and then processes described below are performed when two identifiers are the same.

Meanwhile, when the Authorization Key Identifiers are not identical, it is determined that the subscriber station and the base station generate the Authorization Key Identifier using the different authorization keys, sequence number of the authorization key, base station identifiers or subscriber station MAC addresses, and the PKMv2 SA-TEK-Challenge message is discarded.

When the PKMv2 SA-TEK-Challenge message is successfully authenticated and the same Authorization Key Identifiers are determined, the message is determined as valid message so that the subscriber station 100 transmits the PKMv2 SA-TEK-Request message including all the security algorithms that the subscriber station supports to the base station 200 (S150). The base station 200 performs the message authentication based on the message authentication code parameter included in the PKMv2 SA-TEK-Request message.

When the message is successfully authenticated, the base station 200 can determine whether the base station-contained Authorization Key Identifier, particularly the Authorization Key Identifier included in the PKMv2 SA-TEK-Challenge message, is equal to the Authorization Key Identifier included in PKMv2 SA-TEK-Request message. When the same Authorization Key Identifiers are determined, the base station 200 provides SAIDs and the algorithms corresponding to one available primary SA and 0 or more static SAs to the subscriber station 100 through the PKMv2 SA-TEK-Response message. Accordingly, the subscriber station 100 receives the PKMv2 SA-TEK-Response message and finishes the SA-TEK process. Lastly, all the authentication processes are finished (S160). At this time, the subscriber station 100 performs the PKMv2 SA-TEK-Response message authentication and finishes the SA-REK process when the message is successfully authenticated.

According to such an exemplary embodiment, a reliable information exchange is performed by exchanging the subscriber station security algorithm and the SA information through the SA-TEK process including the message authentication function in the RSA-based authentication process.

Meanwhile, when the above RSA-based authentication process is successfully performed and the subscriber station and the base station share the authorization key, a traffic encryption key generation and distribution process is performed so as to encrypt traffic data transmitted between the subscriber station and the base station. Through such process, the traffic data can be reliably transmitted between the subscriber station and the base station. The traffic encryption key generation and distribution process will be described hereinafter.

An authorization key generation method according the first example of the first exemplary embodiment of the present invention is now described in detail.

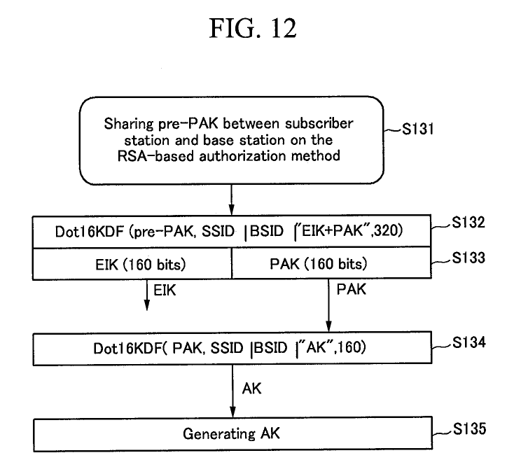

FIG. 12 is a flowchart for generating authorization key in an authentication method performing only an RSA-based authentication process according to the first example of the first exemplary embodiment of the present invention.

As shown in FIG. 12, when the RSA-based authentication process is successfully completed, the subscriber station and the base station share a pre-PAK (i.e., of 256 bits) (S131). The pre-PAK is randomly generated by the base station. The base station encrypts the pre-PAK using a subscriber station public key and transmits the encrypted pre-PAK to the subscriber station. The encrypted pre-PAK is decrypted by the subscriber station having only a private key forming a pair with the subscriber station public key.

The subscriber station 100 obtains a pre-PAK by decrypting the encrypted pre-PAK transmitted from the base station with the secret key. In addition, a key generation algorithm is performed when the pre-PAK is input as an input key, and the subscriber station MAC address, base station identifier, and a predetermined string, for example string words “EIK+PAK”, are input as input data (S132). The key generation algorithm according to exemplary embodiments of the present invention is given as “Dot16KDF” using a CMAC algorithm. However, it is not limited thereto.

Predetermined bits, for example a higher 320 bits are truncated from result data generated according to the key generation algorithm. Predetermined bits, for example a higher 160 bits among the truncated data (320 bit data), is used as an EIK (EAP Integrity Key), and other bits, for example a lower 160 bits, is used as a PAK (S133). The generated EIK is used as an input key on the generation of a message authentication code parameter, CMAC-Digest or HMAC-Digest, for authenticating a PKMv2 Authenticated-EAP-Transfer message in a method for performing the RSA-based authentication process and then the authenticated EAP-authorization process.

Next, the subscriber station 100 performs the key generation algorithm (i.e., Dot16KDF) by having the PAK as the input key and having a subscriber station MAC address, base station identifier, and a string word “AK” as the input data (S134). In addition, predetermined bits, for example a higher 160 bits are truncated from the result data and used as an authorization key (AK) (S135).

The base station 200 also generates the authorization key based on the pre-PAK transmitted to the subscriber station as described above, and accordingly, the subscriber station and the base station share the same authorization key.

An authorization key having a hierarchic structure may be generated according to such an authorization key generation method.

An authentication method and authorization key generation method according to a second example of the first exemplary embodiment of the present invention is now described in detail. According to a second example of the first exemplary embodiment of the present invention, the authentication method selected in a subscriber station basic capability negotiation process performs only the EAP-based authentication process.

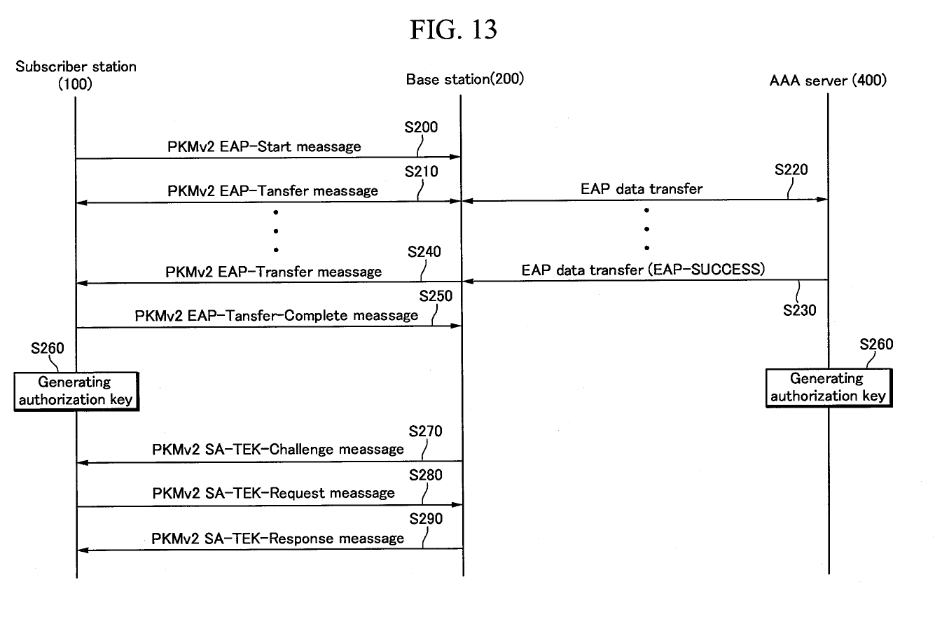

FIG. 13 is a flowchart of an authentication method performing only an EAP-based authentication process according to the second example of the first exemplary embodiment of the present invention.

As shown in FIG. 13, the subscriber station 100 transmits a PKMv2 EAP-start message to the base station 200 so as to inform the EAP authorization protocol of the network that the EAP-based authentication process is started (S200). The base station 200 receiving the message transmits the message through the MAC layer to the higher EAP authorization protocol layer, and transmits a PKMv2 EAP-transfer message inquiring authentication information of the subscriber station 100 according to a request transmitted from the higher EAP authorization protocol layer. The subscriber station 100 transmits the PKMv2 EAP-transfer message including the subscriber station information in response to this message to the base station, and the base station 200 transmits the message to the authentication server 400.

Thereafter, the subscriber station 100 and the base station 200 link to the authentication server 400 and transmit the data to the other node whenever the EAP data is received from the higher EAP authorization protocol layer according to the EAP authorization protocol process through the PKMv2 EAP-Transfer message (S210 to S220).

When the PKMv2 EAP-Transfer messages are transmitted between the subscriber stations 100 and the base station 200 many times according to the higher EAP authorization protocol process in this manner, the subscriber station or base station equipment authentication or user authentication is achieved at the higher EAP authorization protocol layer included in the subscriber station and the authentication server. The number of PKMv2 EAP-Transfer messages transmitted between the subscriber station and the base station is changed according to the higher EAP authorization protocol.

When the subscriber station or base station equipment authentication or user authentication is successfully performed through the higher EAP authorization protocol (S230), the base station 200 transmits the PKMv2 EAP-Transfer message informing of authentication success to the subscriber station 100 (S240). Accordingly, the subscriber station 100 transmits the PKMv2 EAP-Transfer-Complete message to the base station so as to inform of a successful completion of EAP-based authentication process, and the base station 200 finishes the EAP-based authentication process when the base station receives the message (S250).

When such an EAP-based authorization process is successfully completed, the subscriber station 100 and the base station 200 can share the MSK (Master Session Key) according to the higher EAP-based authentication process characteristic. When the subscriber station 100 and the base station 200 share the MSK, they generate the PMK (Pairwise Master Key) using the MSK. In addition, the subscriber station 100 and the base station 200 respectively generate the authorization key using the PMK, the subscriber station MAC address, and the base station identifier through an authorization key generation process described hereinafter (S260).

After the authentication process is completed, the subscriber station 100 and the base station 200 perform a 3-Way SA-TEK exchange process so as to synchronize the Authorization Key Identifier, the authorization key sequence number, the SAID, the algorithm to be used for the respective SAs, and the traffic encryption keys (TEKs). This 3-Way SA-TEK exchange process is performed in the same manner as in the first example. Accordingly, a detailed description thereof will be omitted (S270 to S290). Then, the subscriber station and the base station generate and distribute the traffic encryption key so that the subscriber station and the base station can reliably transmit/receive the traffic data.

An authorization key generation method according to the second example of the first exemplary embodiment of the present invention is now described in detail.

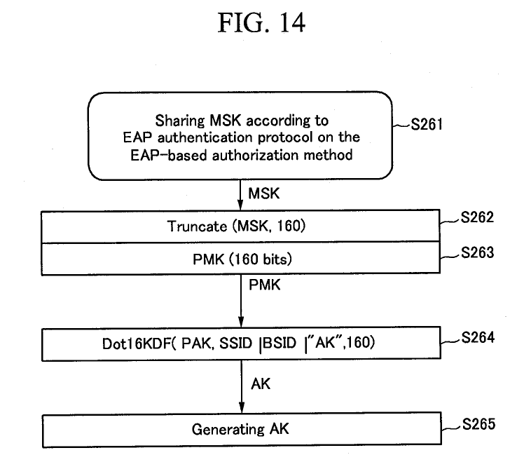

FIG. 14 is a flowchart for generating authorization key in an authentication method performing only an EAP-based authentication process according to the second example of the first exemplary embodiment of the present invention.

When the EAP-based authorization process is successfully completed, the subscriber station and the base station selectively share the MSK of 512 bits according to the higher EAP-based authentication process characteristic as shown in FIG. 14 (S261). When the subscriber station and the base station share the MSK, predetermined bits, for example a higher 160 bits of the MSK, are truncated, and the truncated data, that is, the 160 bit data, is used as the PMK (S262 to S263).

The subscriber station performs the key generation algorithm (i.e., Dot16KDF using a CMAC algorithm) by having the PMK as the input key and having a subscriber station MAC address, a base station identifier, and a string word “AK” as the input data, obtains result data, truncates predetermined bits, for example a higher 160 bits from the result data, and uses the truncated data as the authorization key (S264 to S265).

The authorization key having a hierarchic structure may be generated according to such an authorization key generation method.

An authentication method and authorization key generation method according to a third example of the first exemplary embodiment of the present invention is now described in detail. According to the third example of the first exemplary embodiment of the present invention, the authentication method selected in a subscriber station basic capability negotiation process performs the RSA-based authentication process and then the EAP-based authentication process.

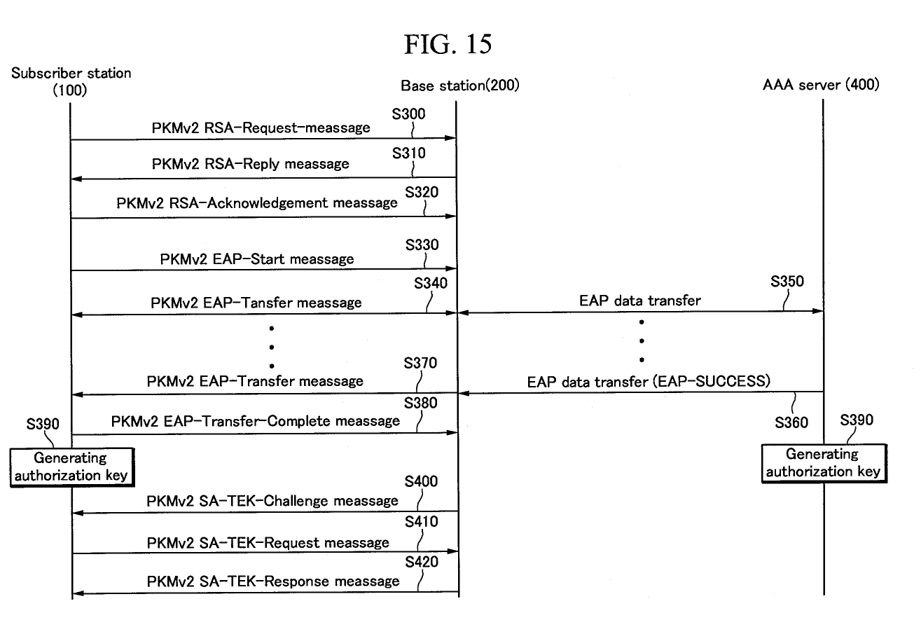

FIG. 15 is a flowchart of an authentication method for sequentially performing an RSA-based authentication process and an EAP-based authentication process according to the third example of the first exemplary embodiment of the present invention.

The subscriber station 100 and the base station 200 perform a mutual authentication through the PKMv2 RSA-Request message and the PKMv2 RSA-Reply message in the same manner as in the first example, and the subscriber station 100 transmits the PKMv2 RSA-Acknowledgement to the base station 200, and accordingly, finishes the RSA-based authentication process when the subscriber station and the base station equipment are successfully mutually authenticated (S300 to S320). The subscriber station 100 and the base station 200 share the pre-PAK according to the RSA-based authentication process and generate the PAK using the key (S330).

Hereinafter, the subscriber station 100 and the base station 200 start the EAP-based authentication process in the same manner as in the second example through the PKMv2 EAP-Start message, exchange the plurality of PKMv2 EAP-Transfer messages according to the higher EAP-based authentication protocol, and perform the user authentication (S340 to S380).

When the EAP-based authentication process is successfully finished, the subscriber station and the base station selectively share the MSK according to the higher EAP-based authentication protocol, and generate the PMK using the shared MSK. Lastly, the subscriber station 100 and the base station 200 respectively generate the authorization key through the authorization key generation process described hereinafter using the PAK generated through the RSA-based authentication process or the PMK generated through the EAP-based authentication process, and the subscriber station MAC address and the base station identifier (S390).

After such an authentication process is completed, the subscriber station 100 and the base station 200 perform the 3-Way SA-TEK exchange process so as to synchronize the Authorization Key Identifier, the authorization key sequence number, the SAID, the algorithm to be used for the respective SAs, and the traffic encryption keys (TEKs) (S400 to S420). This 3-Way SA-TEK exchange process is performed in the same manner as described above. Accordingly, a detailed description thereof is omitted. In addition, the subscriber station and the base station generate and distribute the traffic encryption key so that the subscriber station and the base station reliably transmit/receive the traffic data.

An authorization key generation method according to a third example of the first exemplary embodiment of the present invention is now described in detail.

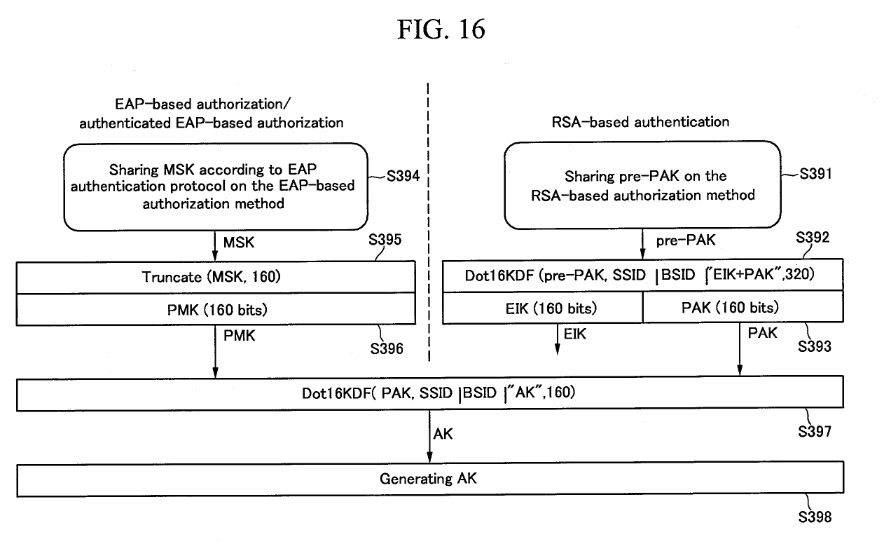

FIG. 16 is a flowchart for generating authorization key in an authentication method for sequentially performing an RSA-based authentication process and an EAP-based authentication process according to the third example of the first exemplary embodiment of the present invention. In this example, the authorization key generation method is applied only when the subscriber station and the base station share the MSK. When the subscriber station and the base station share no MSK, the authorization key may be generated according to the authorization key generation method shown in FIG. 12.

As shown in FIG. 16, when the RSA-based authentication process is successfully finished, the subscriber station 100 and the base station 200 share a pre-PAK (i.e., 256 bits) (S391). In addition, a key generation algorithm is performed when the pre-PAK is input as an input key, and the subscriber station MAC address, base station identifier, and a predetermined string, for example string words “EIK+PAK”, are input as input data (S392). Predetermined bits, for example a higher 320 bits, are truncated from result data generated according to the key generation algorithm, predetermined bits, for example a higher 160 bits among the truncated data (320 bit data), are used as an EIK (EAP Integrity Key), and other bits, for example a lower 160 bits, are used as the PAK (S393).

When the RSA-based authentication process and then EAP-based authorization process are successfully completed, the subscriber station and the base station share the MSK of the 512 bits according to the higher EAP-authorization protocol characteristic (S394). When the subscriber station and the base station share the MSK, predetermined bits, for example a higher 160 bits of the MSK, are truncated, and the truncated data, that is, the 160 bit data, are used as the PMK (S395 to S396).

A result value obtained by a predetermined operation, i.e., an exclusive-or operation of the PAK and PMK obtained as described above, is set as an input key. In addition, the subscriber station performs the key generation algorithm (i.e., Dot16KDF using a CMAC algorithm) by having the result value as the input key and having a subscriber station MAC address, a base station identifier, and a string word “AK” as the input data, obtains result data, truncates predetermined bits, for example a higher 160 bits, from the result data, and uses the truncated data as the authorization key (S397 to S398).

The authorization key having a hierarchic structure may be generated according to such an authorization key generation method.

An authentication method and authorization key generation method according to a fourth example of the first exemplary embodiment of the present invention is now described in detail. According to the fourth example of the first exemplary embodiment of the present invention, the authentication method selected in a subscriber station basic capability negotiation process performs the RSA-based authentication process and then the authenticated EAP-based authentication process.

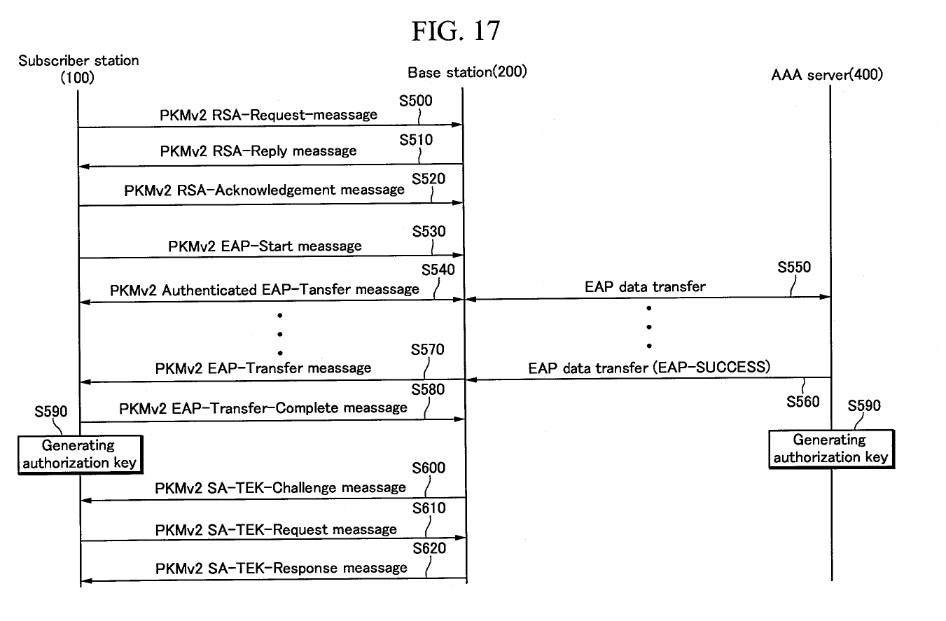

FIG. 17 is a flowchart of an authentication method for sequentially performing an RSA-based authentication process and an EAP-based authentication process according to a fourth example of the first exemplary embodiment of the present invention.

As shown in FIG. 17, the subscriber station and base station are authenticated based on the RSA-based authentication process in the same manner as in the first example of the first exemplary embodiment, they share the pre-PAK, and they generate the PAK using the shared pre-PAK (S500 to S520).

The subscriber station 100 and the base station 200 start the EAP-based authentication process in the same manner as in the second example through the PKMv2 EAP-Start message, exchange the plurality of PKMv2 EAP-Transfer messages according to the higher EAP-based authentication protocol, and perform the user authentication (S530 to S580).

When the EAP-based authentication process is successfully finished, the subscriber station and the base station selectively share the MSK according to the higher EAP-based authentication protocol, and generate the PMK using the shared MSK. Lastly, the subscriber station 100 and the base station 200 respectively generate the authorization key through the authorization key generation process described hereinafter using the PAK or the PMK, and the subscriber station MAC address and the base station identifier (S590). Such an authorization key generation method is performed in the same manner as in the third example (see FIG. 16). Accordingly, a detailed description thereof is omitted. Meanwhile, the EIK obtained based on the PAK is used as an input key for generating the message authentication code parameter (CMAC-Digest or HMAC-Digest) for authenticating the PKMv2 Authenticated-EAP-Transfer message.

After the authentication process is completed, the subscriber station 100 and the base station 200 perform the 3-Way SA-TEK exchange process so as to synchronize the Authorization Key Identifier, the authorization key sequence number, the SAID, the algorithm to be used for the respective SAs, and the traffic encryption keys (TEKs) (S600 to S620). This 3-Way SA-TEK exchange process is performed in the same manner as in the first example. Accordingly, a detailed description thereof is omitted. In addition, the subscriber station and the base station generate and distribute the traffic encryption key so that the subscriber station and the base station reliably transmit/receive the traffic data.

As described above, according to the first exemplary embodiment in which the subscriber station and the base station use the authorization key derived from the PAK obtained through the RSA-based authentication process or the PMK obtained through the EAP-based authentication process, the subscriber station MAC address and base station identifier rather than the subscriber station and the base station use the generated random numbers, the authorization key lifetime may be selected as a relatively shorter time from the PAK lifetime and the PMK lifetime defined by the authentication policy. The authorization key can be robustly maintained when the authorization key lifetime becomes shorter.

According to the first exemplary embodiment, reliable information provision is achieved by exchanging the security-related information through performing the respective authorization processes according to the authorization policy negotiation and then essentially performing the SA_TEK process.

In addition, the authorization key having a hierarchical structure may be generated according to the respective authorization methods because the PAK or PMK generated according to the authenticating process is respectively used as an input key of a key generation algorithm for generating an authorization key.

An authentication method and authorization key generation method according to the second exemplary embodiment of the present invention will now be described.

The authentication method according to the second exemplary embodiment of the present invention includes at least one of performing only an RSA-based authentication method, performing only an EAP-based authorization method, sequentially performing an RSA-based authentication and an EAP-based authorization method, and performing an RSA-based authentication and then an authenticated EAP-based authorization method according to an authentication method selected during the subscriber station basic capability negotiation process as described above in the same manner as in the first exemplary embodiment. In addition, the subscriber station and the base station generate and distribute the traffic encryption key after performing the authentication process according to the respective method so that the subscriber station and the base station reliably transmit/receive the traffic data.

The authentication process according to the respective authentication methods of the second exemplary embodiment is the same as that of the first exemplary embodiment. Accordingly, it is not described in detail.

However, according to the second exemplary embodiment of the present invention, the authorization key is generated during the SA-TEK process unlike in the first exemplary embodiment.

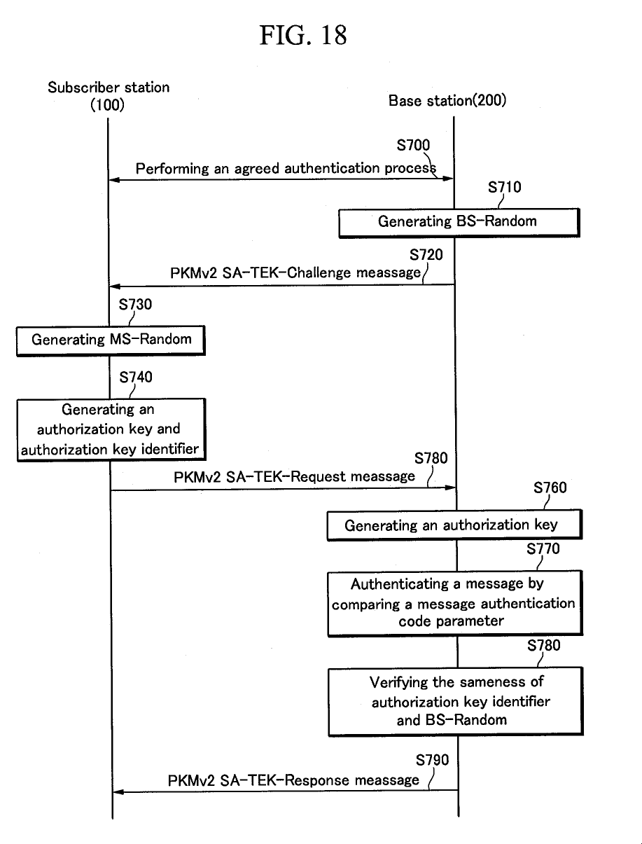

FIG. 18 is a flowchart of an authentication method according to a second exemplary embodiment of the present invention, and particularly, a flowchart showing a SA-TEK process.

As shown in FIG. 18, even in the second exemplary embodiment of the present invention, the subscriber station and the base station finish the respective authentication processes according the negotiated authentication method (S700), and then the subscriber station and the base station performs the SA-TEK process so as to exchange the subscriber station security algorithm and SA information.

In more detail, the base station 200 transmits the PKMv2 SA-TEK-Challenge message to the subscriber station 100, and accordingly starts the SA-TEK process. In addition, the base station 200 informs the authorization key sequence number having the same characteristic as the first exemplary embodiment to the subscriber station 100, and does not inform the Authorization Key Identifier unlike the first exemplary embodiment. In addition, the base station generates the base station random number (BS_Random) of the randomly generated 64 bits and informs the same to the subscriber station. That is, the PKMv2 SA-TEK-Challenge message including the authorization key sequence number and the randomly generated 64 bit value (BS_Random) is transmitted to the subscriber station 100 (S710 to S720).

The subscriber station 100 receiving such a PKMv2 SA-TEK-Challenge message randomly generates the subscriber station random number (MS_Random) of 64 bits (S730). In addition, an authorization key is derived from the subscriber station random number (MS_Random), the base station random number (BS_Random) included in the PKMv2 SA-TEK-Challenge message, the PAK or PMK obtained through one authentication process, the subscriber station MAC address, and the base station identifier. In addition, the subscriber station 100 generates an Authorization Key Identifier based on the known authorization key, and a sequence number thereof included in the PKMv2 SA-TEK-Challenge message, the subscriber station MAC address, and the base station identifier (S740).

In addition, the subscriber station 100 transmits the PKMv2 SA-TEK-Request message including all the security-related algorithms that the subscriber station supports and the generated Authorization Key Identifier to the base station 200 (S750). At this time, the PKMv2 SA-TEK-Request message includes the message authentication code parameter, CMAC-Digest or HMAC-Digest, and such a message authentication code parameter is generated based on the authorization key.

The base station 200 generates an authorization key using the subscriber station random number (MS_Random), the base station random number (BS_Random) used in the PKMv2 SA-TEK-Challenge message, the PAK or PMK obtained through one combined authentication process, the subscriber station MAC address, and the base station identifier.

Hereinafter, based on the authorization key, the base station 200 performs an authentication process for the PKMv2 SA-TEK-Request message by achieving a message authentication function included in the PKMv2 SA-TEK-Request message, that is, a legality of the CMAC-Digest or HMAC-Digest, (S760 to S770).

When the PKMv2 SA-TEK-Request message is successfully authenticated, the base station 200 generates an Authorization Key Identifier based on the authorization key and determines whether the self-generated Authorization Key Identifier is equal to the Authorization Key Identifier included in the PKMv2 SA-TEK-Request message, and an equality of the base station random numbers as well (S780).

In more detail, the base station 200 generates an Authorization Key Identifier based on the known authorization key, the sequence number thereof included in the PKMv2 SA-TEK-Request message, the subscriber station MAC address, and the base station identifier. In addition, it is confirmed that the generated Authorization Key Identifier is equal to the Authorization Key Identifier included in the PKMv2 SA-TEK-Request message.

In addition, the base station 200 confirms whether it has the same base station random number (BS-Ransom). That is, it is determined whether the base station random number transmitted while being included in the PKMv2 SA-TEK-Challenge message in the step S720 is equal to the base station random number included in the PKMv2 SA-TEK-Request message received in the step S750.

When the same Authorization Key Identifiers and the base station random numbers are given, the base station 200 transmits the PKMv2 SA-TEK-Response message including the SA information to the corresponding subscriber station. When the subscriber station 100 receives the PKMv2 SA-TEK-Response message, the SA-TEK process is finished, which completes the authentication process (S790). Meanwhile, the valid PKMv2 SA-TEK-Response message is determined, and accordingly, the SA-TEK process is finished when the subscriber station 100 successfully authenticates the PKMv2 SA-TEK-Response message, the Authorization Key Identifiers are identical, and the MS-Random included in the PKMv2 SA-TEK-Response message is equal to the MS-Random included in the PKMv2 SA-TEK-Request message, among the subscriber station random numbers of the step S740.

According to an exemplary embodiment of the present invention, the receiving node, that is, the subscriber station or base station, determines the message to be valid when a predetermined message satisfies all the sameness criteria of the message authentication code parameters, Authorization Key Identifiers, and random numbers during the SA-TEK process. However, the present invention is not limited thereto. It may be determined whether the messages are valid as described above even, in the SA-TEK process according to the first exemplary embodiment.

An authorization key generation method according the second exemplary embodiment of the present invention is now described in detail.

According to the second exemplary embodiment of the present invention, the authorization key is derived from the subscriber station random number (MS_Random) and the base station random number (BS_Random) included in the SA-TEK process as well as the PAK obtained through the RSA-based authentication process or the PMK obtained through the EAP-based authentication process, the subscriber station MAC address, and the base station identifier.

First, the authentication method performing only the RSA-based authentication process and the authorization key generation method according to a first example of the second exemplary embodiment of the present invention will be described.

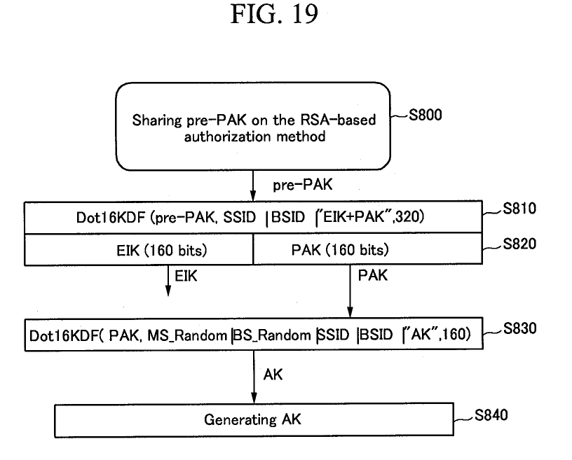

FIG. 19 is a flowchart for generating authorization key in an authentication method performing only an RSA-based authentication process according to a second exemplary embodiment of the present invention.

When the RSA-based authentication process is successfully finished and the subscriber station 100 and the base station 200 share a pre-PAK of 256 bits (S800), a key generation algorithm is performed by having the pre-PAK as an input key, and the subscriber station MAC address, the base station identifier, and string words “EIK+PAK” as input data (S810) as the first example of the first exemplary embodiment shown in FIG. 19. In addition, predetermined bits, for example a higher 160 bits among the result data (320 bit data) obtained by the key generation algorithm, is used as the EIK, and other bits, for example a lower 160 bits, are used as the PAK (S820).

Meanwhile, when the SA-TEK process is performed after the RSA-based authentication process, the subscriber station and the base station have the subscriber station random number (MS_Random) and base station random number (BS_Random) by exchanging the MS_Random and BS_Random during the SA-TEK process.

In the first example of the second exemplary embodiment, the subscriber station and base station perform the key generation algorithm by having the PAK as the input key and having the subscriber station MAC address, the base station identifier, the subscriber station random number (MS_Random) and the base station random number (BS_Random), and a string word “AK” as the input data (S830). In addition, predetermined bits, for example a higher 160 bits of the result data are used as the authorization key (S840).

An authorization key generation method according to a second example of the second exemplary embodiment of the present invention is now described in detail. According to the second example of the second exemplary embodiment of the present invention, the authentication method selected in a subscriber station basic capability negotiation process performs the EAP-based authentication process.

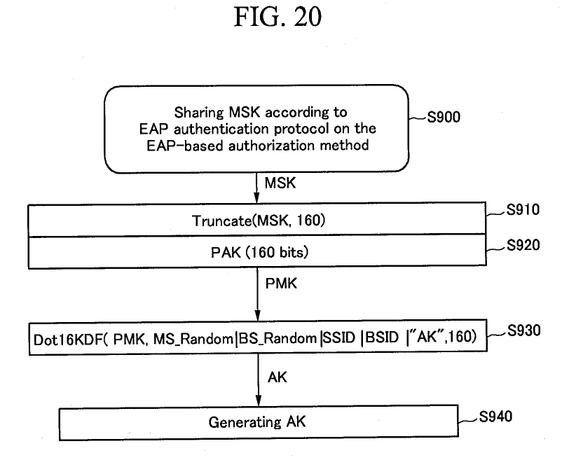

FIG. 20 is a flowchart for generating authorization key in an authentication method performing only an EAP-based authentication process according to a second exemplary embodiment of the present invention.

When such an EAP-based authorization process is successfully finished, the subscriber station 100 and the base station 200 share an MSK (i.e., of 512 bits) according to the higher EAP-based authentication process characteristic (S900). In this case, predetermined bits, for example a higher 160 bits of the MSK are used as the PMK in the same manner as in the second example of the first exemplary embodiment (S910 to S920).

When the SA-TEK process is performed after the EAP-based authentication process, the subscriber station and the base station have the subscriber station random number (MS_Random) and base station random number (BS_Random) by exchanging the MS_Random and BS_Random during the SA-TEK process. The subscriber station and the base station perform the key generation algorithm by having the PMK as the input key and having the subscriber station MAC address, the base station identifier, the subscriber station random number (MS_Random) and the base station random number (BS_Random), and the string word “AK” as the input data. In addition, predetermined bits, for example a higher 160 bits of the result data are used as the authorization key (S930 to S940).

An authorization key generation method according to a third example of the second exemplary embodiment of the present invention is now described in detail. According to the third example of the second exemplary embodiment of the present invention, the authentication method selected in a subscriber station basic capability negotiation process performs the RSA-based authentication process and then the EAP-based authentication process.

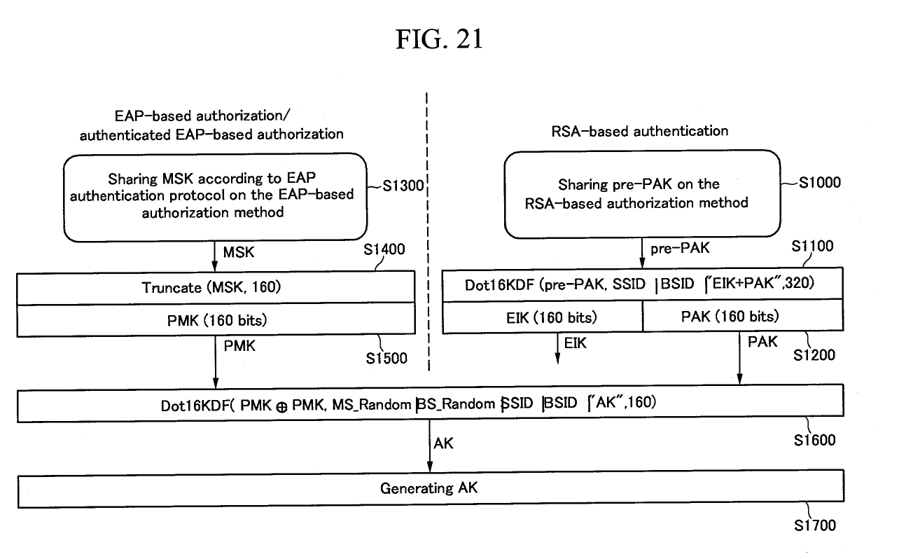

FIG. 21 is a flowchart for generating authorization key in an authentication method for sequentially performing an RSA-based authentication process and an EAP-based authentication process according to the second exemplary embodiment of the present invention.

This authorization key generation method is applied only when the subscriber station and the base station share the MSK through the EAP-based authentication process. The authorization key may be generated according to the same authorization key generation method as in the first example of the first exemplary embodiment shown in FIG. 12, when the subscriber station and the base station share no MSK although they sequentially perform an RSA-based authentication process and the EAP-based authentication process.

When the RSA-based authentication process is successfully finished, the subscriber station 100 and the base station 200 share the pre-PAK of 256 bits and generate the EIK and PAK (S1100 to S1200). In addition, the subscriber station 100 and the base station 200 exchange the plurality of PKMv2 EAP-Transfer messages according to the higher EAP-based authentication protocol, and accordingly perform the subscriber station equipment, base station equipment, or user authentication. When the EAP-based authentication process is successfully finished, the subscriber station and the base station share the MSK according to the higher EAP-based authentication protocol (S1300). In this case, the subscriber station and the base station generate the PMK using the shared MSK (S1400 to S1500).

However, the authorization key is derived from the subscriber station random number (MS_Random) and the base station random number (BS_Random) obtained in the SA-TEK process, unlike the third example of the first exemplary embodiment. The subscriber station and base station generate a resulting value by a predetermined operation, i.e., the exclusive- or operation of the PAK and PMK. In addition, the subscriber station performs the key generation algorithm by having the resulting value as the input key and having the subscriber station MAC address, the base station identifier, the subscriber station random number (MS_Random) and the base station random number (BS_Random), and the string word “AK” as the input data, and accordingly, obtains the result data. In addition, predetermined bits, for example a higher 160 bits of the result data are used as the authorization key (S1600 to S1700).

An authorization key generation method in the authentication method for performing the RSA-authentication process and then the authenticated EAP-based authorization process according to a fourth example of the second exemplary embodiment of the present invention is the same as the authorization key generation method according to the third example of the second exemplary embodiment described above. This authorization key generation method is applied only when the subscriber station and the base station share the MSK through the RSA-based authentication process and then the authenticated EAP-based authentication process. The authorization key may be generated according to the authorization key generation method of the first example of the first exemplary embodiment shown in FIG. 12, when the subscriber station and the base station share no MSK although they sequentially perform an RSA-based authentication process and an EAP-based authentication process. Therefore, it is not described in detail.

According to the first exemplary embodiment, a reliable information provision is achieved by exchanging the security-related information through performing the respective authorization processes according to the authorization policy negotiation and then essentially performing the SA_TEK process.

In addition, the authorization key having a hierarchical structure may be generated according to the respective authorization methods because the PAK or PMK generated according to the authenticating process is respectively used as the input key of a key generation algorithm for generating an authorization key.

As described above, according to the first exemplary embodiment, the authorization key lifetime may select a relative short time from the PAK lifetime and the PMK lifetime defined by the authentication policy. In this case, the authorization key can be robustly maintained because the authorization key lifetime becomes shorter.

In addition, according to the second exemplary embodiment, the authorization key lifetime may select a relative short time among the PAK lifetime, the PMK lifetime, and the random number lifetime. In this way, the authorization key can be more robustly maintained because the authorization key lifetime becomes shorter.

In addition, the PAK lifetime is provided from the base station to the subscriber station during the RSA-based authentication process. However, the PMK lifetime may be provided from the higher EAP authorization protocol layer to the respective subscriber station and the base station, or may be provided from the base station to the subscriber station during the SA-TEK exchange process. In addition, the random number lifetime may be provided from the base station to the subscriber station during the SA-TEK exchange process.

In addition, in the case that the authentication method performs only an RSA-based authentication process, the authorization key lifetime is set by the PAK lifetime, and the PAK is updated through the RSA-based authentication process as described above before the authorization key lifetime is expired. When the PAK is successfully updated, the subscriber station and base station respectively update the PAK and the PAK lifetime, the authorization key is re-generated with the updated PAK, and the authorization key lifetime is set to be equal to the updated PAK lifetime.

In addition, when the authentication method performs only an EAP-based authorization process, the authorization key lifetime is set as the PMK lifetime and the subscriber station can update the PMK through the EAP-based authorization process as described above before the authorization key lifetime is expired. When the PMK is successfully updated, the authorization key can be re-generated with the updated PMK, the PMK lifetime can be transmitted from the EAP authorization protocol layer or updated through the SA-TEK exchange process, and the authorization key lifetime can be set to be equal to the updated PMK lifetime.

A message authentication key generation method will now be described, the message authentication key for generating a message authentication code parameters for authenticating a message (a PKMv2 Authenticated-EAP-Transfer message) used in the authenticated EAP-based authorization process in the case that the RSA-authentication process and then the authenticated EAP-based authorization process are performed according to the authentication method negotiated between the subscriber station and the base station in the first and second exemplary embodiments of the present invention.

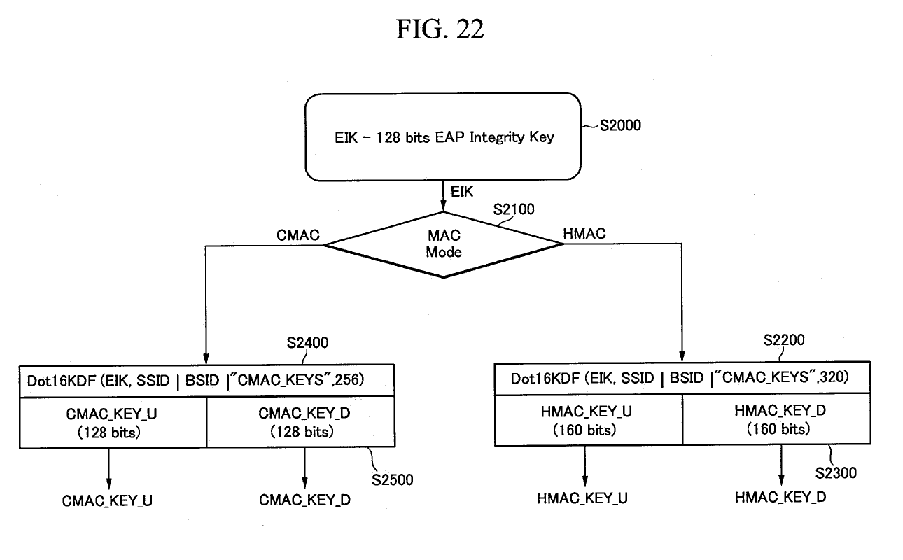

FIG. 22 is a flowchart for a message authentication key, particularly for generating an HMAC key or a CMAC key for authenticating a message using an EIK according to first and second exemplary embodiments of the present invention. This method is effective only when the authentication policy negotiated between the subscriber station and the base station is the authentication method for sequentially performing an RSA-based authentication process and an authenticated EAP-based authentication process. That is, the message authentication key, HMAC key or CMAC key, is generated, and the message authentication key is used to generate the HMAC-Digest or CMAC-Digest included in the PKMv2 Authenticated-EAP-Transfer message used during the authenticated EAP-based authentication process, based on the EIK obtained through the pre-PAK included in the PKMv2 RSA-Reply message transmitted from the base station to the subscriber station during the RSA-based authentication process.

In more detail, as shown in FIG. 22, when the RSA-based authentication process is successfully completed, the subscriber station 100 and the base station 200 generate the EIK (128 bits) using the pre-PAK (S2000).

In addition, when HMAC is determined as a message authentication method through the subscriber station basic capability negotiation process, a key generation algorithm is performed by having the EIK shared by both the subscriber station 100 and the base station 200 as an input key, and by having the subscriber station MAC address, the base station identifier, and a string word “HMAC_KEYS” as input data (S2100 to S2200).

Predetermined bits, for example a higher 320 bits, are truncated from result data generated according to the key generation algorithm, and predetermined bits, for example a higher 160 bits of the truncated data, are used as a first input key, that is, an input key HMAC_KEY_U for generating the HMAC-Digest included in the PKMv2 Authenticated-EAP-Transfer message transmitted in the uplink. In addition, other bits, for example a lower 160 bits of the truncated data, are used as a second input key, that is, an input key HMAC_KEY_D for generating the HMAC-Digest included in the PKMv2 Authenticated-EAP-Transfer message transmitted in the downlink (S2300).

When CMAC is determined as a message authentication method through the subscriber station basic capability negotiation process, a key generation algorithm is performed by having the EIK shared by both the subscriber station 100 and the base station 200 as the input key, and by having the subscriber station MAC address, the base station identifier, and a string word “CMAC_KEYS” as the input data (S2400).

In addition, predetermined bits, for example a higher 256 bits, are truncated from result data generated according to the key generation algorithm, and predetermined bits, for example a higher 128 bits of the truncated data, are used as a first input key, that is, an input key CMAC_KEY_U for generating the CMAC-Digest included in the PKMv2 Authenticated-EAP-Transfer message transmitted in the uplink. In addition, other bits, for example a lower 128 bits of the truncated data, are used as a second input key, that is, an input key CMAC_KEY_D for generating the CMAC-Digest included in the PKMv2 Authenticated-EAP-Transfer message transmitted in the downlink (S2500).

The HMAC-Digest or CMAC-Digest included in the message authentication code parameter is generated based on the message authentication key (HMAC_KEY_U, HMAC_KEY_D, CMAC_KEY_U, CMAC_KEY_D) derived in this manner.

A process for generating and distributing a traffic encryption key so as to encrypt traffic data received/transmitted between the subscriber station and the base station when the subscriber station equipment, base station equipment, or user authentication process is successfully performed according to the first and second exemplary embodiments will now be described.

First, a structure of a message used to generate a traffic encryption key will be described.

According to an exemplary embodiment of the present invention, a message transmitted/received between the subscriber station and base station during the traffic encryption key generation and distribution process includes random number so as to prevent a replay attack for the corresponding message. The subscriber station and the base station independently maintain the random number, and a receiving node for receiving a message including the random number determines whether the message has been replay-attacked or not according to a relationship between the random number included the message and the pre-stored random number. If the message has been replay-attacked, the message is discarded and, if not, the corresponding message is used for a predetermined process.

Such a random number may be generated in a first format or a second format.

The random number is considered as a value having the first format when it may be generated along a direction in which a predetermined value is increased or decreased as a counter. For example, when the random number is generated in the first format, the random number may be set as a value in which +1 is continuously increased or −1 is continuously decreased by a given value.

When the random number is generated in the first format, a receiving node for receiving a message including the random number on the predetermined traffic encryption key generation and distribution process stores only the random number having a maximum or minimum value among the random numbers rather than that the node stores and manages all the random numbers included in the respective messages. Therefore, the receiving node stores one random number (the maximum or minimum random number) until the traffic encryption key corresponding to the receiving node is expired, and when the traffic encryption key is expired the stored random number is deleted.

In this case, when the receiving node receives a predetermined message, the receiving node determines whether the random number (i.e., a first random number) including in the message exceeds the previously stored random number (i.e., the second random number), and if exceeds, it considers the received message as a message that is not replay-attacked. In addition, when the first random number exceeds the second random number, the second random number is deleted and the first random number is stored so that the first random number is used as a random number for determining a replay attack for the next-received message.

At this time, it is considered that the first random number exceeds the second random number if the first random number is greater than the second random number, because the second random number is the maximum random number when the random number is generated along a direction in which a predetermined value is increased as a counter. Therefore, the receiving node considers the message as a replay-attacked message and discards the same when the first random number included in the received message is less than or equal to the second random number.

On the other hand, it is considered that the first random number exceeds the second random number if the first random number is less than the second random number, because the second random number is the minimum random number when the random number is generated along a direction in which a predetermined value is decreased as a counter. Therefore, the receiving node considers the message as a replay-attacked message and discards the same when the first random number included in the received message is greater than or equal to the second random number.

In addition, the random number is considered as a value having the second format when the random number may be randomly generated, unlike a counter. At this time, the random number may be randomly set regardless of the previously-used values.

When the random number is generated in the second format, a node receiving messages including the random number during the predetermined traffic encryption key generation and distribution process stores and manages all the random numbers included in the respective messages until the corresponding traffic encryption key is expired. In addition, when the traffic encryption key is expired, all the random numbers corresponding to the traffic encryption key are deleted.

In this case, when the receiving node receives a predetermined message, the receiving node determines whether the random number (i.e., a first random number) including in the message is equal to one or more previously stored random numbers (i.e., the second random number). That is, the message is considered as the replay-attacked message and discarded when the first random number is equal to at least one of the second random numbers. On the other hand, the message is considered to not be a replay-attacked message and is used when the first random number is not equal to all the second random numbers. In addition, the first random number is stored and managed along with the pre-stored second random numbers so that the first random number is used as a random number for determining a replay-attack for the next-received message.

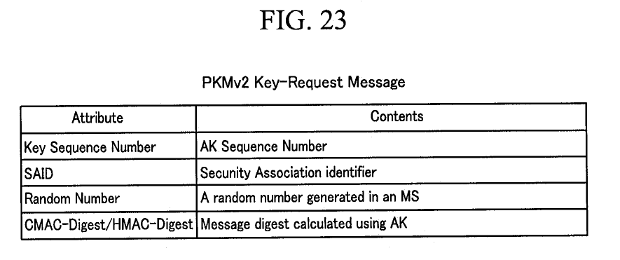

FIG. 23 is a table showing an internal parameter structure of a PKMv2 Key-Request message among messages used in traffic encryption key generation and distribution processes according to exemplary embodiments of the present invention.

A PKMv2 Key-Request message is for the subscriber station requesting of the base station a traffic encryption key and traffic encryption key-related parameters corresponding to a SA_ID which the subscriber station has, and may be referred to as “traffic encryption key request message.”

The PKMv2 Key-Request message includes an authorization key sequence number, a SAID, a random number, and a message authentication code parameter, CMAC-Digest or HMAC-Digest.

The authorization key sequence number is a sequential consecutive number for the authorization key. The message authentication key used when the message authentication code parameter, CMAC-Digest or HMAC-Digest, included in the PKMv2 Key-Request message is generated, may be derived from the authorization key. The two authorization keys may be simultaneously used. Therefore, the authorization key sequence number is used to distinguish between the two authorization keys.

The SAID is an identifier of the SA. The SA is a set including necessary parameters to encrypt the traffic data as well as the traffic encryption key. In addition, one single SA may be mapped with one or more traffic connection.

The random number is used to prevent a replay attack for the message. When the subscriber station transmits the PKMv2 Key-Request message, the subscriber station generates the random number in the first format or the second format and includes the same in the message. Therefore, when the base station receives the message, the base station determines whether the received message is replay-attacked or not according to the format of the random number as described above, and if it is replay-attacked, the base station discards the message.

The message authentication code parameter, CMAC-Digest or HMAC-Digest, is a parameter used to authenticate the PKMv2 Key-Request message itself. The subscriber station generates the CMAC-Digest or HMAC-Digest by applying other parameters of the PKMv2 Key-Request message excluding the message authentication code parameter to the Message Hash function based on the authorization key.

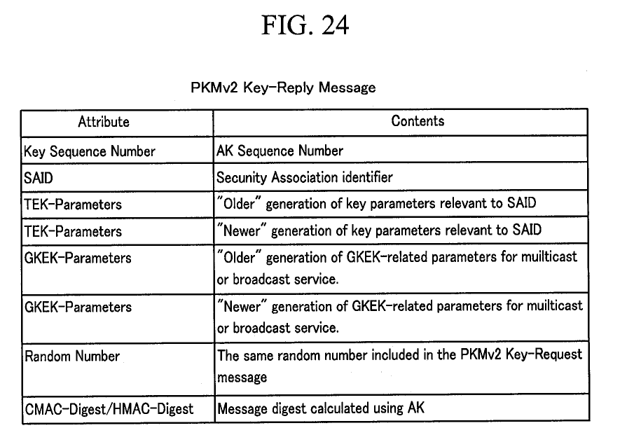

FIG. 24 is a table showing an internal parameter structure of a PKMv2 Key-Reply message among messages used in traffic encryption key generation and distribution processes according to exemplary embodiments of the present invention.

When the base station generates a traffic encryption key for the corresponding SAID according to the PKMv2 Key-Request message, a PKMv2 Key-Reply message is for informing it of the subscriber station. It may be referred to as a “traffic encryption key response message.”

When the base station receives the PKMv2 Key-Request message as the traffic encryption key request message corresponding to a predetermined SAID from the subscriber station, the base station verifies the message authentication using the message authentication code parameter CMAC-Digest or HMAC-Digest. In addition, when the authentication is successfully finished, the traffic encryption key for the corresponding SAID is generated, included in the PKMv2 Key-Reply message and transmitted to the subscriber station. At this time, when the subscriber station successfully receives the PKMv2 Key-Reply message, the traffic encryption key generation and distribution process is finished.

Such a PKMv2 Key-Reply message includes an authorization key sequence number, a SAID, a traffic encryption key-related parameter (TEK-Parameters), a group key encryption key-related parameter (GKEK-Parameters), a random number, and a message authentication code parameter (CMAC-Digest or HMAC-Digest).

The authorization key sequence number is for distinguishing authorization keys for generating message authentication keys used when the message authentication code parameter CMAC-Digest or HMAC-Digest included in the PKMv2 Key-Request message is generated as described above. The SAID is an identifier of the SA and is equal to the SAID included in the PKMv2 Key-Request message.

The traffic encryption key-related parameter (TEK-Parameters) includes parameters for encrypting the traffic data. For example, it includes a traffic encryption key, a traffic encryption key sequence number, a traffic encryption key lifetime, a CBC-IV, and a concerning group key encryption key sequence number (Associated GKEK Sequence Number). The PKMv2 Key-Reply message may include two traffic encryption key-related parameters, that is, a traffic encryption key-related parameter to be used during the present lifetime and a traffic encryption key-related parameter to be used during the next lifetime.

The group key encryption key-related parameter (GKEK-Parameters) includes parameters for encrypting traffic data corresponding to a multicast service, a broadcast service, or an MBS service. For example, it includes a Group Key Encryption Key (GKEK), a group key encryption key lifetime, and a group key encryption key sequence number. The PKMv2 Key-Reply message may include two group key encryption key-related parameters, that is, a group key encryption key-related parameter to be used during the present lifetime and a group key encryption key-related parameter to be used during the next lifetime. Meanwhile, the group key encryption key-related parameter is included only when the SA corresponding to a multicast service, a broadcast service, or an MBS service are defined.

The random number is used to prevent a replay attack for the message. When the base station transmits the PKMv2 Key-Reply message, the base station generates the random number in the first format or second format and includes the same in the message. Therefore, when the subscriber station receives the message, the base station determines whether the received message is replay-attacked or not according to the format of the random number as described above, and if it is replay-attacked, subscriber station discards the message.

The message authentication code parameter, CMAC-Digest or HMAC-Digest, is a parameter used to authenticate the PKMv2 Key-Reply message. The base station generates the CMAC-Digest or HMAC-Digest by applying other parameters of the PKMv2 Key-Reply message excluding the message authentication code parameter to the Message Hash function based on the authorization key.

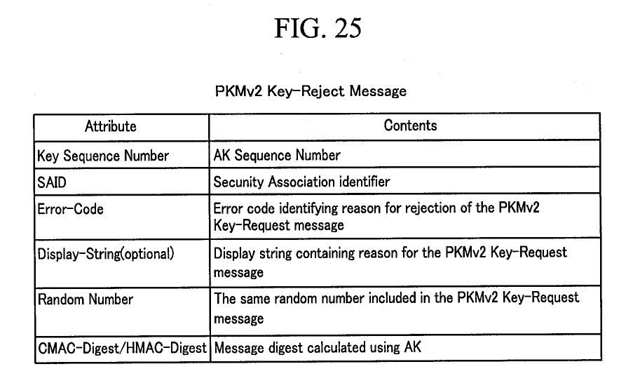

FIG. 25 is a table showing an internal parameter structure of a PKMv2 Key-Reject message among messages used in traffic encryption key generation and distribution processes according to first and second exemplary embodiments of the present invention.

The PKMv2 Key-Reject message is used to inform that the base station fails to generate a traffic encryption key according to the PKMv2 Key-Request message of the subscriber station. When the base station receives the PKMv2 Key-Request message and successfully authenticates the same, the base station transmits the PKMv2 Key-Reject message to the subscriber station if the requested traffic encryption key for the corresponding SAID is not successfully generated. When the subscriber station receives the PKMv2 Key-Reject message, the subscriber station again retransmits the PKMv2 Key-Request message to the base station, and accordingly again requests the traffic encryption key.

The PKMv2 Key-Reject message includes an authorization key sequence number, a SAID, an Error Code, a Display-String, a random number, and a message authentication code parameter, CMAC-Digest or HMAC-Digest.

The authorization key sequence number is a sequential consecutive number for distinguishing authorization keys for generating message authentication keys used when the message authentication code parameter, CMAC-Digest or HMAC-Digest, included in the PKMv2 Key-Request message is generated as described above. The SAID is an identifier of the SA and is equal to the SAID included in the PKMv2 Key-Request message.

The Error Code specifies a reason that the base station rejects the traffic encryption key request of the subscriber station, and the Display-String provides a reason that the base station rejects the traffic encryption key request of the subscriber station as a string.

The random number is used to prevent a replay attack for the message. When the base station transmits the PKMv2 Key-Reject message, the base station generates the random number in the first format or second format and includes the same in the message. Therefore, when the subscriber station receives the message, the base station determines whether the received message is replay-attacked or not according to the format of the random number as described above, and if it is replay-attacked, subscriber station discards the message.

The message authentication code parameter, CMAC-Digest or HMAC-Digest, is a parameter used to authenticate the PKMv2 Key-Reject message itself. The base station generates the CMAC-Digest or HMAC-Digest by applying other parameters of the PKMv2 Key-Reply message excluding the message authentication code parameter to the Message Hash function based on the authorization key.

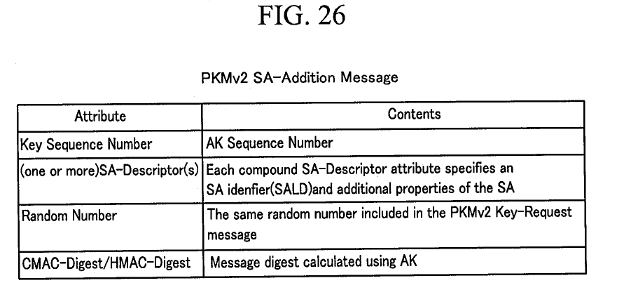

FIG. 26 is a table showing an internal parameter structure of a PKMv2 SA-Addition message among messages used in traffic encryption key generation and distribution processes according to first and second exemplary embodiments of the present invention.

A PKMv2 SA-Addition message is transmitted to the subscriber station when the base station dynamically generates and distributes one or more SA to the subscriber station, and may be referred to as a “SA dynamic addition message.”

That is, the message is used when the traffic connection is dynamically added between the subscriber station and the base station and a traffic encryption function for the corresponding traffic connection is supported.

The PKMv2 SA-Addition message includes an authorization key sequence number, one or more SA descriptor, a random number, and a message authentication code parameter, CMAC-Digest or HMAC-Digest.

The authorization key sequence number is a sequential consecutive number for the authorization keys as described above.

The SA descriptor includes a SAID, which is a SA identifier, a SA type for informing of a type of SA, a SA service type for informing of a traffic service type of SA and defined when the SA type is dynamic or static, and an encryption suite for informing of an encryption algorithm used in the corresponding SA. The SA descriptor may be repeatedly defined by the number of SA that the base station dynamically generates.

The random number is used to prevent a replay attack for the message. When the base station transmits the PKMv2 SA-Addition message, the base station generates the random number in the first format or the second format and includes the same in the message. Therefore, when the subscriber station receives the message, the base station determines whether the received message is replay-attacked or not according to the format of the random number as described above, and if it is replay-attacked, subscriber station discards the message.

The message authentication code parameter, CMAC-Digest or HMAC-Digest, is a parameter used to authenticate the PKMv2 SA-Addition message. The base station generates the CMAC-Digest or HMAC-Digest by applying other parameters of the PKMv2 SA-Addition message excluding the message authentication code parameter to the Message Hash function based on the authorization key.

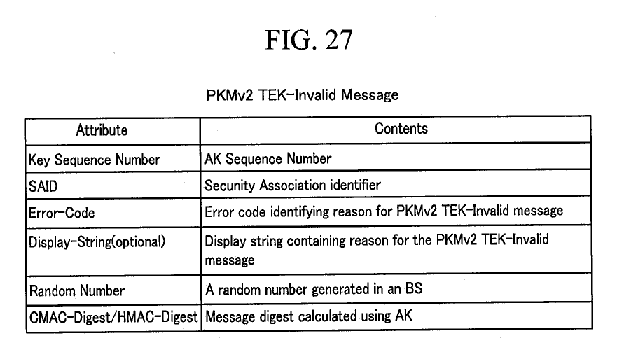

FIG. 27 is a table showing an internal parameter structure of a PKMv2 TEK-Invalid message among messages used in traffic encryption key error informing processes according to first and second exemplary embodiments of the present invention.

When the traffic encryption key used to encrypt the traffic data is not appropriated, a PKMv2 TEK-Invalid message is used to inform it of the subscriber station. It may be referred to as a “traffic encryption key error inform message.”

For example, the base station transmits the PKMv2 TEK-Invalid message to the subscriber station so as to inform it when an invalid traffic encryption key is used, for example when an invalid traffic encryption Key sequence number is used. The subscriber station receiving the PKMv2 TEK-Invalid message requests a new SA including a traffic encryption key corresponding to the SAID included in the received message. In order to request and receive the new traffic encryption key, the subscriber station and the base station use the PKMv2 Key-Request message and the PKMv2 Key-Reply message.

The PKMv2 TEK-Invalid message includes an authorization key sequence number, a SAID, an Error Code, a Display-String, a random number, and a message authentication code parameter, CMAC-Digest or HMAC-Digest.

The authorization key sequence number is a sequential consecutive number for the authorization keys as described above. The SAID is an identifier of the SA. Particularly, it implies a SA identifier included in the invalid traffic encryption key. If including such SAID, the subscriber station and the base station must generate and distribute a new traffic encryption key corresponding to the SAID.

The Error Code specifies a reason that the base station rejects the traffic encryption key request of the subscriber station, and the Display-String provides a reason that the base station rejects the traffic encryption key request of the subscriber station as a string.

The random number is used to prevent a replay attack for the PKMv2 TEK-Invalid message. When the base station transmits the PKMv2 TEK-Invalid message, the base station generates the random number in the first format or second format and includes the same in the message. Therefore, when the subscriber station receives the message, the base station determines whether the received message is replay-attacked or not according to the format of the random number as described above, and if it is replay-attacked, subscriber station discards the message.

The message authentication code parameter, CMAC-Digest or HMAC-Digest, is a parameter used to authenticate the PKMv2 TEK-Invalid message. The base station generates the CMAC-Digest or HMAC-Digest by applying other parameters of the PKMv2 TEK-Invalid message excluding the message authentication code parameter to the Message Hash function based on the authorization key.

A traffic encryption key generation and distribution process according to an exemplary embodiment of the present invention is now described in detail based on the messages described above.

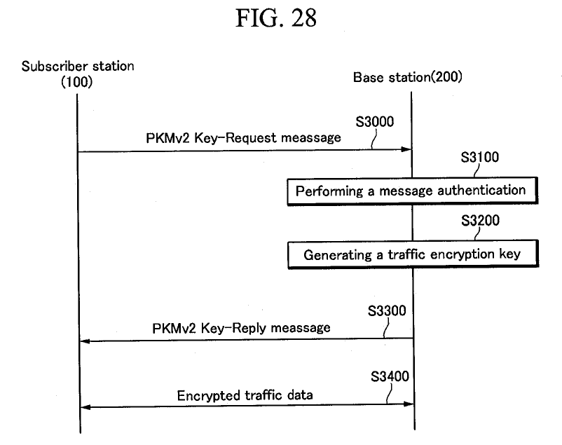

FIG. 28 is a flowchart showing traffic encryption key generation and distribution processes according to first and second exemplary embodiments of the present invention.

After the authentication, the subscriber station 100 transmits a PKMv2 Key-Request message to request the traffic encryption key for the traffic data security to the base station 200 (S3000). The base station 200 receiving this message performs a message authentication function so as to verify that the corresponding message is received from the valid subscriber station (S3100).

When the message is successfully authenticated, the base station 200 generates a traffic encryption key corresponding to the SA included in the PKMv2 Key-Request message (S3200), and transmits the PKMv2 Key-Reply message including the traffic encryption key to the subscriber station 100. Accordingly, the traffic encryption key generation and distribution process is finished (S3300).

However, at the step S3100, when the message is not successfully authenticated, the base station discards the received PKMv2 Key-Request message. In addition, the base station 200 transmits the PKMv2 Key-Reject message to the subscriber station and rejects the traffic encryption key request of the subscriber station when the traffic encryption key is not generated, for example because there is no SAID corresponding to the requested traffic encryption key even though the message authentication for the PKMv2 Key-Request message is successful.

In this manner, the subscriber station and the base station share the traffic encryption key so that stable traffic data transmission is achieved based on the shared traffic encryption key (S3400).

Meanwhile, the SA dynamic addition process may be performed between the subscriber station and the base station. In this case, the base station 200 transmits the PKMv2 SA-Addition message to the subscriber station 100 so as to add one or more SA. The subscriber station 100 receiving the PKMv2 SA-Addition message finishes the process when the message is successfully authenticated and the message is normally received. As a result, the SA of the subscriber station is dynamically added.

In addition, the base station can perform an invalid traffic encryption key usage informing process. At this time, the base station 200 transmits the PKMv2 TEK-Invalid message to the subscriber station 100 so as to inform the invalid traffic encryption key usage of the corresponding SA. The subscriber station 100 finishes the process and requests a new traffic encryption key generation and distribution from the base station 200 when the message is successfully authenticated and the message is normally received.

The above-described authentication method and key (authorization key and traffic encryption key etc.) generation method may be realized in a program format stored in a recording medium that a computer can read. The recording medium may include all types of recording media that a computer can read, for example an HDD, a memory, a CD-ROM, a magnetic tape, and a floppy disk, and it may also be realized in a carrier wave (e.g., Internet communication) format.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

According to the above described exemplary embodiments of the present invention, effectiveness has been obtained as follows.

First, a robust authentication function can be provided by performing an authentication process by a combination variously selected from the RSA-based authentication method, the EAP-based authentication method, and the authenticated EAP-based authentication method.

Second, on being authenticated, the reliability of the security-related parameters received from the other node is enhanced by adding a message authentication function to the authentication-related messages for transmitting the primary parameters exchanged between the subscriber station and the base station.

Third, an efficient and hierarchical PKMv2 framework can be provided because the subscriber station equipment and base station equipment authentication and user authentication function is performed through the selective various combinations of the authentication methods, and a multi-hierarchical authentication method performing the additional SA-TEK exchange process is defined so as to generate an authorization key or transmit the authorization key and security-related parameters.

Fourth, authorization key generation methods may be selectively used according to an authentication policy of a service provider by respectively realizing a case (a first exemplary embodiment) that does not use random numbers that the subscriber station and the base station randomly generate and transmit the generated random numbers to the other node during the SA-TEK process and a case (a second exemplary embodiment) that uses the same.

Fifth, a hierarchical and secure authorization key structure can be provided by providing a method for identically using PAK and PMK as the input key in the case that an authorization key is generated with the PAK that the subscriber station and the base station share through the RSA-based authentication process and the PMK that both nodes may share through the EAP-based authentication process.

Sixth, the authorization key is more robustly managed by selecting the authorization key lifetime as a relatively shorter time from the PAK lifetime and PMK lifetime defined by an authorization policy.

Seventh, in an authentication policy defined such that the RSA-based authentication process is performed and then authenticated EAP-based authentication process is performed, the authenticated EAP-based authorization process can be perfectly supported by providing a message authentication key generation method for generating keys used to generate the message authentication parameter, HMAC-Digest or CMAC-Digest, which performs a message authentication function with respect to the messages included in the authenticated EAP-based authentication process.

Eighth, the subscriber station and base station can share a reliable valid traffic encryption key in the traffic encryption key generation and distribution process by adding the message authentication function to the messages of the corresponding process.

Ninth, the base station can add a reliable SA in the dynamic SA addition process by adding the message authentication function to the messages of the corresponding process.

Tenth, in the case that the base station informs it the subscriber station that the traffic encryption key for encrypting the uplink traffic data is invalid, a usage of an invalid traffic encryption key can be recognized from a reliable base station can be informed by adding the message authentication function to the messages of the corresponding processes.

1. An authentication method for a first node being a base station or a subscriber station performing an authentication process while linking a second node being the subscriber station or the base station in a wireless portable Internet system, the authentication method comprising:
a) performing an authentication process corresponding to an authentication scheme set by a negotiation between the first node and the second node;
b) obtaining one or more basic key for generating an authorization key shared with the second node according to the authentication process;
c) generating the authorization key based on a first node identifier, a second node identifier, and the basic key; and
d) exchanging a security algorithm and SA (security association) information with the second node based on additional authentication process messages including authorization key-related parameter and security-related parameter.

2. An authentication method for a first node being a base station or a subscriber station performing an authentication process while linking a second node being the subscriber station or the base station in a wireless portable Internet system, the authentication method comprising:
a) performing an authentication process corresponding to an authentication scheme set by a negotiation between the first node and the second node;
b) obtaining one or more basic keys for generating an authorization key shared between the first and second nodes according to the authentication process; and
c) exchanging a security algorithm and SA (Security Association) information with the second node based on additional authentication process messages including the authorization key-related parameter and security-related parameter, the second node,
wherein the step c) further comprises generating an authorization key based on the first node identifier, a first random number that the first node randomly generates, the basic key, the second node identifier, and a second random number that the second node randomly generates.

3. An authentication method for a first node being a base station or a subscriber station performing an authentication process while linking a second node being the subscriber station or the base station in a wireless portable Internet system, the authentication method comprising:
a) performing an authentication process corresponding to an authentication scheme set by a negotiation between the first node and the second node;
b) obtaining an authorization key shared between the first and second nodes according to the authentication process; and
c) exchanging a security algorithm and SA (Security Association) information with the second node based on additional authentication process messages including authorization key-related parameter and security-related parameter.

4. The authentication method of claim 1, wherein the authentication method is at least one of a Rivest Shamir Adleman (RSA)-based authentication scheme for performing a mutual equipment authorization by the subscriber station and the base station;
an Extensible Authentication Protocol (EAP)-based authentication scheme for performing a subscriber station equipment and base station equipment authentication and user authentication by using a higher EAP protocol;
an authentication scheme for performing the RSA-based authentication and then the EAP-based authentication; and
an authentication scheme for performing the RSA-based authentication and then an authenticated EAP-based authentication.

5. The authentication method of claim 1, wherein the corresponding node identifier is given as a subscriber station MAC (media access control) address when the first node or the second node is given as the subscriber station.

6. The authentication method of claim 1, wherein when the RSA-based authentication process is performed at the step a), the step b) includes obtaining a pre-PAK (pre-Primary Authorization Key) according to the RSA-based authentication process, generating a PAK (Primary Authorization Key) with the pre-PAK, and setting the PAK as the basic key.

7. The authentication method of claim 1, wherein when the EAP-based authentication process is performed at the step a), the step b) includes selectively obtaining an MSK (Master Session Key) according to a higher EAP authorization protocol characteristic; generating a PMK (Pairwise Master Key) with the obtained MSK; and setting the PMK as a basic key.

8. The authentication method of claim 1, wherein when the RSA-based authentication process and then the EAP-based authentication process are performed at the step a), the step b) includes obtaining a pre-PAK after the RSA based authentication process and generating a PAK based on the pre-PAK; selectively obtaining an MSK (Master Session Key) according to an EAP authorization protocol characteristic after the EAP-based authentication process or the authenticated EAP-based authentication process and generating a PMK (Pairwise Master Key) with the obtained MSK; and setting the PMK or the PAK as the basic key.

9. The authentication method of claim 4, wherein the step a) in the case of the performing of the RSA-based authentication further includes performing the subscriber station equipment authentication according to the RSA authentication request message that the base station receives from the subscriber station, the message including a subscriber station certificate and further including at least one of a subscriber station random number that the subscriber station randomly generates and a message authentication parameter;
transmitting an RSA authentication response message to the subscriber station and requesting the base station equipment authentication, the RSA authentication response message including an encrypted pre-PAK, a base station certificate, and a key sequence number, and further including at least one of the subscriber station random number, a base station random number that the base station randomly generates, a key lifetime, and a message authentication parameter, when the subscriber station equipment is successfully authenticated; and,
finishing the RSA-based authentication process when the RSA authentication acknowledge message including a base station equipment success result code is received from the subscriber station.

10. The authentication method of claim 9, comprising the base station informing of a subscriber station authentication failure by transmitting an RSA authentication failure message to the subscriber station when the subscriber station equipment is not successfully authenticated; and
the subscriber station informing of a base station authentication failure by transmitting an RSA authentication acknowledgement message including an authentication failure result code to the base station when the base station equipment is not successfully authenticated,
wherein the RSA authentication failure message and the RSA authentication acknowledgement message further include at least one of the subscriber station random number, the base station random number, an Error Code and a Display-String informing of a failure reason, and a message authentication parameter for authenticating a message.

11. The authentication method of claim 4, wherein the step a) in the case of the performing of the EAP-based authentication includes the base station starting an EAP-based authentication process according to an EAP authorization start message for informing of an authentication process start transmitted from the subscriber station;
performing a user authentication by transmitting EAP data through an EAP data transfer message to the subscriber station whenever the base station receives the EAP data from a higher EAP authorization protocol layer; and
finishing the EAP-based authentication when an EAP authorization success message is received from the subscriber station.

12. The authentication method of claim 11, wherein the subscriber station transmits the EAP data through the EAP data transfer message to the base station whenever the subscriber station receives the EAP data from the higher EAP authorization protocol layer.

13. The authentication method of claim 11, wherein the number of EAP data transfer messages transmitted between the subscriber station and the base station is variable according to the higher authentication protocol.

14. The authentication method of claim 1, wherein the step for exchanging the security algorithm and the SA information further includes determining validity of the received message by the receiving node receiving the message of the additional authentication process,
the validity determining step includes determining whether the message authentication code parameter included in the received message is equal to the message authentication code parameter directly generated by the receiving node based on the authorization key;
determining whether the random number included in the received message is equal to the random number included in the random number previously transmitted to the receiving node;
determining whether the authorization key identifier included in the received message is equal to the authorization key identifier contained in the receiving node; and,
determining the message to be valid when the message satisfies the equality of the message authentication code parameters, the random numbers, and the authorization key identifiers.

15. The authentication method of claim 1, further comprising:
the base station starting a SA-TEK process by transmitting a SA-TEK challenge message to the subscriber station;
receiving a SA-TEK request message including all the security-related algorithms that the subscriber station supports from the subscriber station and verifying the message to be valid; and
transmitting a SA-TEK response message including SA and security-related algorithms that the base station can provide to the subscriber station when the message is verified to be valid.

16. The authentication method of claim 15, further comprising the subscriber station receiving a SA-TEK challenge message from the base station; transmitting the SA-TEK request message including all the security-related algorithms that the subscriber station supports to the base station according to the received SA-TEK challenge message; verifying the received SA-TEK response message to be valid; and finishing the SA-TEK process when the SA-TEK response message is verified to be valid.

17. The authentication method of claim 16, wherein the SA-TEK response message includes a SA descriptor, and the SA descriptor includes a SA identifier (SAID), a SA type for informing a type of SA, and a SA service type for informing a SA traffic service type by being defined when the SA type is dynamic or stable SA.

18. The authentication method of claim 16, wherein the SA-TEK challenge message includes the authorization key sequence number and the authorization key identifier, and further includes at least one of the base station random number that the base station randomly generates, the message authentication code parameter, and a PMK lifetime,
wherein the subscriber station transmits the SA-TEK request message including the authorization key identifier included in the SA-TEK challenge message to the base station when the authorization key identifier included in the SA-TEK challenge message corresponds to the authorization key identifier that the subscriber station independently generates.

19. The authentication method of claim 16, wherein the SA-TEK challenge message includes the base station random number that the base station randomly generates and the authorization key sequence number, and it further includes at least one of the random number lifetime and the PMK lifetime,
the step for transmitting the SA-TEK request message to the base station including generating the authorization key based on the base station random number included in the SA-TEK challenge message, and
generating the authorization key identifier based on the generated authorization key and transmitting the SA-TEK request message including the generated authorization key identifier to the base station.

20. The authentication method of claim 18, wherein
the SA-TEK request message includes a subscriber station security algorithm capability, and it further includes at least one of the subscriber station random number that the subscriber station randomly generates, the base station random number that the base station randomly generates and includes in the SA-TEK challenge message, the authorization key sequence number, the authorization key identifier, and the message authentication code parameter, and the authorization key identifier is equal to the authorization key identifier included in the SA-TEK challenge message.

21. The authentication method of claim 19, wherein the SA-TEK request message includes the subscriber station random number that the subscriber station randomly generates, the subscriber station security algorithm capability, and the authorization key identifier, and it further includes the base station random number that the base station randomly generates and includes in the SA-TEK challenge message, the authorization key sequence number, and the message authentication code parameter, and the authorization key identifier is equal to an authorization key identifier that the subscriber station newly generates.

22. The authentication method of claim 18, wherein the SA-TEK response message includes SA update information, and one or more SA descriptor, and it further includes at least one of the SA-TEK update information, the subscriber station random number and the base station random number, the authorization key sequence number, the authorization key identifier, and the message authentication code parameter, and the authorization key identifier is equal to the authorization key identifier included in the SA-TEK challenge message.

23. The authentication method of claim 19, wherein the SA-TEK response message includes one or more SA descriptor, and it further includes at least one of the SA-TEK update information, the subscriber station random number and the base station random number, a authorization key sequence number, an authorization key identifier, and a message authentication code parameter, and the authorization key identifier is equal to the authorization key identifier included in the SA-TEK request message.

24. The authentication method of claim 4, further comprising sharing a traffic encryption key between the base station and the subscriber station, wherein the sharing step includes the base station authenticating the traffic encryption key request message received from the subscriber station; generating the traffic encryption key corresponding to the SA if successfully authenticated; and transmitting a traffic encryption key response message including the traffic encryption key to the subscriber station.

25. The authentication method of claim 24, wherein the messages include a random number for preventing a replay attack, and the receiving node receives the messages and uses or discards the messages according to the random number.

26. The authentication method of claim 25, further comprising when the random number is generated in a first format in which a predetermined value is increased or decreased,
if the first random number in the message exceeds previously stored second random number, the receiving node using the message;
deleting the stored second random number and storing the first random number; and
if the first random number does not exceed the second random number, discarding the messages.

27. The authentication method of claim 26, wherein the receiving node stores the second random number until the traffic encryption key corresponding to the second random number is expired and deletes the second random number when the traffic encryption key is expired.

28. The authentication method of claim 25, further comprising when the random number is generated in a second format, if the first random number included in the message is the same as one of at least one previously stored second random numbers, the receiving node discarding the message, and if the first random number is not the same as all the second random numbers, using the message and managing the same by storing the first random number as one of the second random numbers.

29. The authentication method of claim 28, wherein the receiving node stores all the second random numbers until the traffic encryption key corresponding to the second random numbers is expired and deletes all the second random numbers when the traffic encryption key is expired.

30. The authentication method of claim 24, further comprising the base station transmitting a SA dynamic addition message to the subscriber station, the message including a SA descriptor including SA information to be added and further including at least one of the authorization key sequence number, the random number, and the message authentication code parameter, and dynamically adding the SA to the subscriber station.

31. The authentication method of claim 24, further comprising the base station transmitting a traffic encryption key error information message informing of invalid traffic encryption key usage to the subscriber station, the message including a SA identifier using the traffic encryption key and further including at least one of a authorization key sequence number, an error code, a random number, and a message authentication code parameter, wherein the subscriber station requests a new traffic encryption key distribution from the base station according to the traffic encryption key error inform message.

32. An authorization key generation method when a first node being a base station or a subscriber station performing an authentication process while linking a second node being the subscriber station or the base station in a wireless portable Internet system, the authorization key generation method comprising:
a) performing an authentication process corresponding to an authentication scheme set by a negotiation between the first node and the second node and obtaining a first basic key for generating an authorization key;
b) generating a second basic key from the first basic key; and
c) generating the authorization key by performing a key generation algorithm using the second basic key as an input key and using the first node identifier, the second node identifier, and a predetermined string word as input data.

33. An authorization key generation method when a first node being a base station or a subscriber station performing an authentication process while linking a second node being the subscriber station or the base station in a wireless portable Internet system, the authorization key generation method comprising:
a) performing an authentication process corresponding to an authentication scheme set by a negotiation between the first node and the second node and obtaining a first basic key for generating an authorization key;
b) generating a second basic key from the first basic key; and
c) generating the authorization key by performing a key generation algorithm using the second basic key as the input key and using a first node identifier, a first random number that the first node randomly generates, a second node identifier, a second random number that the second node randomly generates, and predetermined string word as the input data.

34. The authorization key generation method of claim 32, wherein the corresponding node identifier is given as a subscriber station MAC (media access control) address when the first node or the second node is given as a subscriber station.

35. The authorization key generation method of claim 32, wherein when the authentication scheme performs only an RSA-based authentication process which the subscriber station and the base station respectively performs a mutual authentication, the first basic key is given as a pre-PAK, and the step b) includes
obtaining first result data by performing a key generation algorithm using the pre-PAK as the input key and using a subscriber station identifier, a base station identifier, and a predetermined string as the input data;
extracting predetermined bits from the first result data; and
setting first predetermined bits of the extracted predetermined-bit data as a second basic key, that is, a PAK.

36. The authorization key generation method of claim 32, wherein when an authentication method performs only an EAP-based authentication process for performing the subscriber station equipment and the base station equipment authentication or user authentication using a higher EAP authorization protocol, the first basic key is given as an MSK,
and the step b) includes setting the second basic key PMK by extracting predetermined bits of the first basic key, that is, the MSK.

37. The authorization key generation method of claim 32, wherein when EAP-based authorization process or authenticated EAP-based authorization process is performed after RSA-based authorization process is performed, the step b) includes generating the PAK from the pre-PAK, that is, the first basic key obtained after the RSA-based authentication process;
generating a PMK from the first basic key, that is, MSK obtained after the EAP-based authentication process or authenticated EAP-based authentication process;
obtaining a resulting value by a logic operation on the PAK and PMK; and
setting the resulting value as the second basic key.

38. The authorization key generation method of claim 37, wherein the step for obtaining result value obtains the resulting value by an exclusive operation on the PAK and PMK.

39. A message authentication key generation method for generating a message authentication key parameter for a first node being a base station or a subscriber station performing an authentication process while linking a second node being the subscriber station or the base station in a wireless portable Internet system, the message authentication key generation method comprising:
a) when an authentication process performs an authenticated EAP-based authentication process after an RSA-based authentication process according to an negotiation between the first node and the second node, the first node obtaining a basic key shared with the second nodes through an RSA-based authentication process;
b) obtaining result data by performing a key generation algorithm using the basic key as an input key and using a first node identifier, a second node identifier, and a predetermined string word as input data;
c) extracting predetermined bits of the result data, and using first predetermined bits of the extracted bits as message authentication keys for generating message authentication code parameter of an uplink message; and
d) extracting predetermined bits of the result data and generating second predetermined bits of the extracted bit as a message authentication keys for generating a message authentication code parameter of a downlink message.

40. The authorization key generation method of claim 39, wherein the basic key is given as an EIK (EAP Integrity Key) using a pre-PAK obtained after the RSA-based authentication process.

41. The authorization key generation method of claim 39, wherein the message authentication code parameter uses one scheme selected from message authentication schemes using the HMAC (Hash Message Authentication Code) or CMAC (Cipher-based Message Authentication Code).
